(19) United States
(12) Patent Application Publication
(10) Pub. No.: US 2015/0219831 A1
(43) Pub. Date: Aug. 6, 2015

(54) OPTICAL MEMBER, ILLUMINATION DEVICE, AND DISPLAY DEVICE

(71) Applicant: SHARP KABUSHIKI KAISHA, Osaka-shi, Osaka (JP)

(72) Inventor: Shigenori Tanaka, Osaka (JP)

(73) Assignee: Sharp Kabushiki Kaisha, Osaka (JP)

(21) Appl. No.: 14/427,534

(22) PCT Filed: Sep. 18, 2013
(86) PCT No.: PCT/JP2013/075117

§ 371 Date: Mar. 11, 2015

(30) Foreign Application Priority Data
Sep. 25, 2012 (JP) 2012-211105

(51) Int. Cl. F21V 8/00

(52) U.S. Cl. CPC G02B 6/0051

(57) ABSTRACT

An optical sheet includes: a sheet-like base material having transparent characteristics; an anisotropic light focusing part that is formed over a light-receiving surface of the base material and that has light focusing anisotropy whereby a light focusing effect is exerted on incident light in a light focusing direction along the light-receiving surface but not in a non-light focusing direction along the light-receiving surface, the non-light focusing direction being perpendicular to the light focusing direction; and an anisotropic light diffusing part that is formed over a light exiting surface of the base material and that diffuses and emits light from the anisotropic light focusing part. The anisotropic light diffusing part is provided with anisotropic light diffusing particles that have an elongated shape and that are disposed such that a long-axis direction thereof is in the non-light focusing direction and a short-axis direction thereof is in the light focusing direction, thereby having light diffusion anisotropy such that the intensity of diffused light is relatively large in the light focusing direction and the intensity of diffused light in the non-light focusing direction is relatively small.

### TECHNICAL FIELD

The present invention relates to an optical member, an illumination device, and a display device.

### BACKGROUND ART

In recent years, display elements for image display devices such as television reception devices have been transitioning from conventional vacuum-tubes to thin display panels such as liquid crystal panels, plasma display panels, and so on, and it has become possible to make image display devices thinner. With a liquid crystal display device, the liquid crystal panel used therein does not itself emit light and therefore a backlight device is required separately as an illumination device; backlight devices are broadly divided according to a mechanism thereof into direct-lit types and edge-lit types. An edge-lit backlight device includes a light guide plate that guides light from a light source disposed on an edge portion, and an optical member that applies an optical effect to light from the light guide plate and supplies the light to a liquid crystal panel as uniformly planar light. One such device which is known is that which is described in Patent Document 1 as a turning lens system backlight device in which a prism sheet having a light focusing prism is used as an optical member and the prism is arranged opposite a light guide plate.

### RELATED ART DOCUMENT

### Patent Document

Patent Document 1: Japanese Patent Application Laid-Open Publication No. 2009-300989

### Problem to be Solved by the Invention

With the aforementioned turning lens system backlight device, outstanding frontal luminance can be obtained by efficiently raising the light from the light guide panel with the prism in a frontal direction. On the other hand, however, there is a tendency for emitted light of the backlight device to collect excessively in the frontal direction, and there is a risk of an effective viewing angle of the liquid crystal panel becoming narrow.

### SUMMARY OF THE INVENTION

The present invention was completed based on circumstances such as the aforementioned, and has as an object to mitigate directionality which can arise in emitted light, while maintaining a high frontal luminance related to the emitted light.

### Means for Solving the Problems

An optical member of the present invention includes: a base material that is transparent and has a sheet-like shape, one surface of the base material being a light-receiving surface where light enters and another surface thereof being a light-exiting surface where light exits; an anisotropic light focusing part that is formed over the light-receiving surface of the base material and that exerts, on incident light, a light focusing effect in a light focusing direction along the light-receiving surface of the base material, but does not exert a light focusing effect in a non-light focusing direction along the light-receiving surface of the base material, the non-light focusing direction being perpendicular to the light focusing direction; and an anisotropic light diffusing part that is formed over the light exiting surface of the base material and that diffuses and emits light from the anisotropic light focusing part, the anisotropic light diffusing part including anisotropic light diffusing particles having an elongated shape, a long-axis direction of the elongated shape being in the non-light focusing direction and a short-axis direction thereof being in the light focusing direction, thereby relatively increasing an amount of light diffused in the light focusing direction and relatively decreasing an amount of light diffused in the non-light focusing direction.

In this manner, light entering the light-receiving surface of the sheet-shaped base material is subject to the light focusing action in the light focusing direction by the anisotropic light focusing part which has light focusing anisotropy, but is not subject to a light focusing action in the non-light focusing direction. Light that passes through the base material from the anisotropic light focusing part and reaches the anisotropic light diffusing part formed on the light exiting surface is emitted while being subject to a diffusion action by the anisotropic light diffusing part. Here, the anisotropic light diffusing part is provided with anisotropic light diffusing particles that have an elongated shape and are disposed such that the long-axis direction is in the non-light focusing direction and the short-axis direction is in the light focusing direction, thereby having light diffusion anisotropy such that the intensity of diffused light is relatively large in the light focusing direction and the intensity of diffused light in the non-light focusing direction is relatively small. Diffusion of light that is subject to the light focusing action by the anisotropic light focusing part is promoted by the anisotropic light diffusing part, and diffusion of light that is not subject to the light focusing action by the anisotropic light focusing part is suppressed. In this manner, frontal luminance of emitted light of the optical member can be increased by focusing light in the light focusing direction with the anisotropic light focusing part, and directionality that can occur in emitted light can be mitigated by the anisotropic light diffusing part which has light diffusion anisotropy.

The following configurations are preferable as embodiments of the present invention.

(1) The anisotropic light diffusing part includes a transparent resin layer that is stacked on the light-exiting surface of the base material and that has a large number of the anisotropic light diffusing particles dispersed therein, and, in the transparent resin layer, the anisotropic light diffusing particles are oriented such that the long-axis direction is along the non-light focusing direction and the short-axis direction is along the light focusing direction. In this manner, light that passes through the base material from the anisotropic light focusing part and reaches the anisotropic light diffusing part is diffused, such that an intensity of diffused light is greater in the light focusing direction and an intensity of diffused light is smaller in the non-light focusing direction, by the anisotropic light diffusing particles that are dispersed and mixed in the transparent resin layer and oriented such that the long-axis direction is in the non-light focusing direction and the short-axis direction is in the light focusing direction. Moreover, when manufacturing the optical member, if the anisotropic light diffusing part is laminated and formed by applying and hardening a liquid transparent resin layer, in which a plurality of the anisotropic light diffusing particles have been dispersed and mixed, on the light exiting surface of the base material, for example, a long-axis direction of the anisotropic light diffusing particles is arranged during application so as to be in a direction of application, and therefore the anisotropic light diffusing particles can be oriented easily.

(2) The anisotropic light diffusing particles each have a shape that tapers from a center to both ends thereof in the long-axis direction. Thus, by laminating and forming the anisotropic light diffusing part by applying and hardening the liquid transparent resin layer in which a plurality of the anisotropic light diffusing particles are dispersed and mixed on the light exiting surface of the base material, for example, during manufacturing of the optical member, the long-axis directions of the anisotropic light diffusing particles can be arranged during application in the direction of application more smoothly than in a case in which the anisotropic light diffusing particles have a fixed thickness along an entire length thereof in the long-axis direction. An oriented state of the plurality of anisotropic light diffusing particles in the transparent resin layer can thus be made more appropriate.

(3) The anisotropic light diffusing particles each have a cross-sectional shape that is elliptical along the long-axis direction. End portions in the long-axis direction of the anisotropic light diffusing particles thus have rounded shapes, and therefore there is less catching during a process in which the anisotropic light diffusing particles are oriented during application in a case in which the anisotropic light diffusing part is laminated and formed by applying and hardening the liquid transparent resin layer in which are dispersed and mixed a plurality of the anisotropic light diffusing particles on a light exiting surface of the base material, for example, during manufacturing of the optical member. The long-axis direction of the anisotropic light diffusing particles can thus be arranged even more smoothly so as to be in the direction of application, and an oriented state of the plurality of the anisotropic light diffusing particles in the transparent resin layer can be made even more appropriate.

(4) The anisotropic light diffusing particles each have a cross-sectional shape that is circular along the short-axis direction. Thus, compared to a case in which the anisotropic light diffusing particles have a cross-sectional shape cut along the short-axis direction which is squared, there is less catching during a process in which the anisotropic light diffusing particles are oriented during application in a case in which the anisotropic light diffusing part is laminated and formed by applying and hardening the liquid transparent resin layer in which are dispersed and mixed a plurality of the anisotropic light diffusing particles on an light exiting surface of the base material, for example, during manufacturing of the optical member. The long-axis direction of the anisotropic light diffusing particles can thus be arranged during application more smoothly so as to be in the direction of application, and an oriented state of the plurality of the anisotropic light diffusing particles in the transparent resin layer can be made more appropriate.

(5) The anisotropic light focusing part includes a plurality of prisms, arranged parallel to the light focusing direction, that protrude from the light-receiving surface, the prisms having a substantially ridge-shaped cross section along the light focusing direction and extending linearly in the light focusing direction. The prisms that form the anisotropic light focusing part thus have cross-sectional shapes cut along the light focusing direction which substantially form ridge shapes, and therefore when light incident to the prisms hits sloped faces of the prisms, an angle is created corresponding to vertices of the prisms and the light is raised to a frontal direction. The light focusing action is thus applied to light directed at the base material from the prisms along the light focusing direction. On the other hand, because the prisms extend linearly in the non-light focusing direction, no light focusing action is applied to light directed toward the base material from the prisms along the non-light focusing direction.

Next, in order to solve these problems, an illumination device of the present invention includes the optical member; a light source; and a light guide plate that has a light-receiving face where light from the light source enters, and a light-exiting surface where light exits, the light-exiting surface of the light guide plate facing the light-receiving surface of the optical member.

With an illumination device of this configuration, light from the light source enters the light-receiving face of the light guide plate, is transmitted inside the light guide plate, and is then emitted from the light-exiting surface, thereby entering the light exiting surface of the optical member. Because the frontal luminance related to the emitted light from the optical member is high and directionality which can occur in the emitted light is mitigated, luminance unevenness does not readily occur as frontal luminance is high and orientation which can occur in the emitted light is mitigated in this illumination device, too.

The anisotropic light focusing part of the optical member includes a plurality of prisms, arranged along an arrangement direction of the light source and the light guide plate, that are formed over the light-receiving surface of the optical member, the prisms having a substantially ridge-shaped cross section with a pair of slanted faces along the arrangement direction and extending linearly in a direction perpendicular to the arrangement direction, and with respect to the cross section of the prisms, one of the slanted faces opposite to the light source is a curved line or a polygonal line.

In this manner, the direction of propagation of light from the light-exiting surface of the light guide plate to the light-receiving surface of the optical member tilts generally towards the light-exiting surface, and includes a component in a direction of a normal of the light-exiting surface and a component in a direction from the light source towards the light-receiving face of the optical light guide. In contrast, because the anisotropic light focusing part substantially forms the ridge shapes in which the cross-sectional shape cut along the direction of arrangement of the light source and the light guide plate has the pair of slanted faces, and of the pair of slanted faces the cross-sectional shape of the slanted face on the opposite side of the light source is a curved line or a polygonal line, light entering the prism along the aforementioned direction of propagation can efficiently be raised towards the frontal direction. Frontal luminance can thereby be efficiently improved. Note that the polygonal line mentioned here is a line in which two or more slanted lines having different angles of inclination are connected.

Next, in order to solve these problems, a display device of the present invention includes: the illumination device; and a display panel that performs display with light from the illumination device.

With the display device of this configuration, frontal luminance relating to emitted light of the illumination device is high and luminance unevenness does not readily occur, and therefore display with outstanding display quality can be realized.

A liquid crystal panel can be used as an example of the display panel. This type of display device can be applied to many uses, such as, for example, displays for smartphones and tablet-type personal computers.

### Effects of the Invention

With the present invention, directionality of emitted light which can occur can be mitigated while maintaining high frontal luminance related to the emitted light.

### BRIEF DESCRIPTION OF THE DRAWINGS

FIG. 1 is an exploded perspective view showing a general configuration of a liquid crystal display device according to Embodiment 1 of the present invention.

FIG. 2 is a cross-sectional view showing a cross-sectional configuration along a direction of a short side of the liquid crystal display device.

FIG. 3 is a cross-sectional view showing a cross-sectional configuration along a direction of a long side of the liquid crystal display device.

FIG. 4 is a cross-sectional view in which a vicinity of an LED in FIG. 2 is enlarged.

FIG. 5 is a plan view generally showing a pixel arrangement in a liquid crystal panel.

FIG. 6 is oblique perspective cutout view of an optical sheet.

FIG. 7 is a bottom view generally showing an arrangement of prisms forming an anisotropic light focusing part in the optical sheet.

FIG. 8 is a plan view generally showing an arrangement of anisotropic light diffusing particles that form an anisotropic light diffusing part in the optical sheet.

FIG. 9 is a cross-sectional view in which the optical sheet and a light guide plate are cut along a Y-axis direction.

FIG. 10 is a cross-sectional view in which the optical sheet and the light guide plate are cut along an X-axis direction.

FIG. 11 is a graph showing a luminance distribution of emitted light from a backlight device (prism sheet) according to a comparison example.

FIG. 12 is a graph showing a luminance distribution of emitted light from a backlight device (prism sheet) according to an embodiment.

FIG. 13 is a cross-sectional view in which an optical sheet and a light guide plate according to Embodiment 2 of the present invention are cut along a Y-axis direction.

FIG. 14 is a cross-sectional view in which an optical sheet and a light guide plate according to Embodiment 3 of the present invention are cut along a Y-axis direction.

FIG. 15 is a perspective cutout view of an optical sheet according to Embodiment 4 of the present invention.

FIG. 16 is a perspective cutout view of an optical sheet according to Embodiment 5 of the present invention.

FIG. 17 is a perspective cutout view of an optical sheet according to Embodiment 6 of the present invention.

### DETAILED DESCRIPTION OF EMBODIMENTS

### Embodiment 1

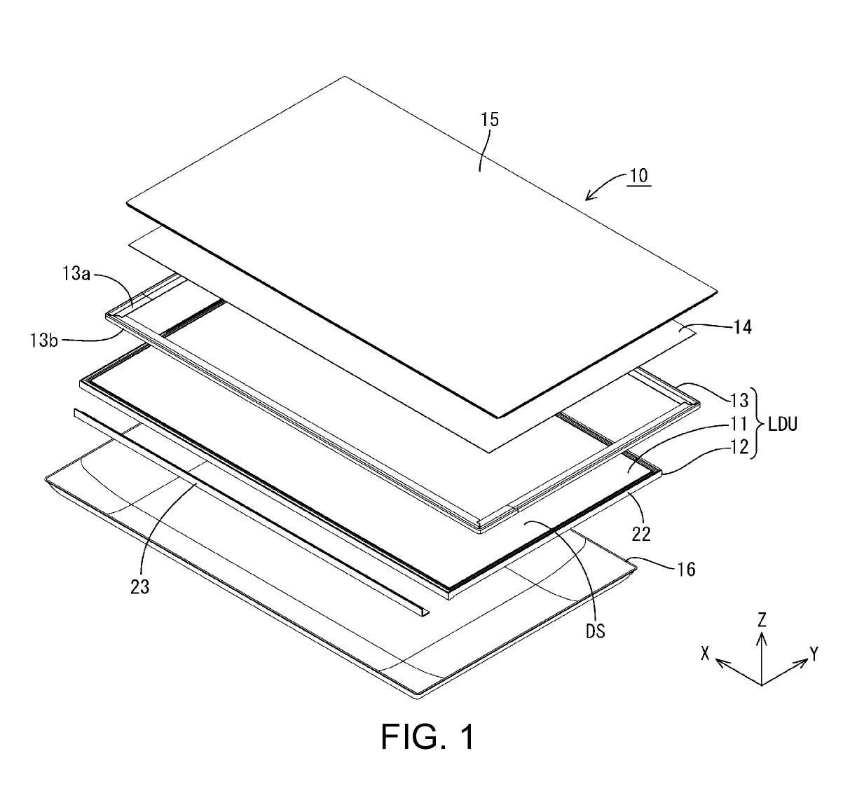

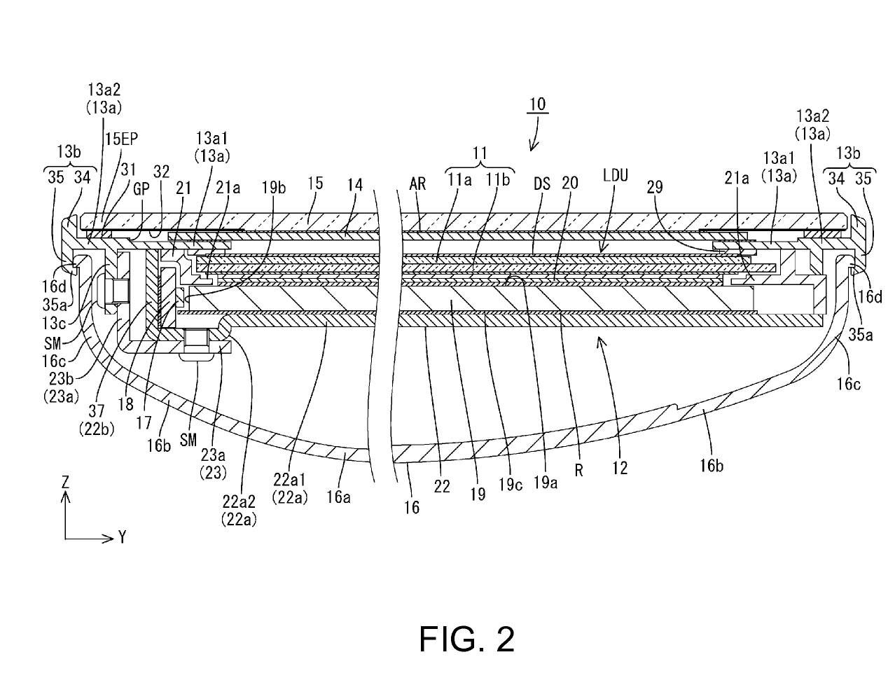

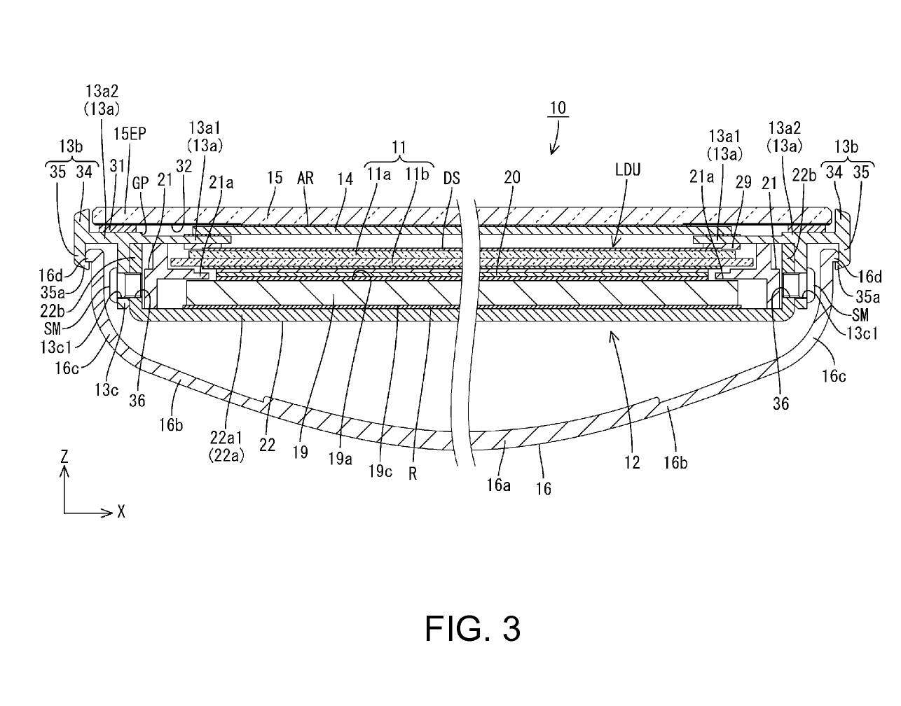

Embodiment 1 of the present invention is described with reference to FIGS. 1 through 12. In the present embodiment, a liquid crystal display device 10 is used as an example. Note that an X-axis, a Y-axis, and a Z-axis are shown in parts of the drawings, drawn such that the directions shown in the drawings are the same throughout. Furthermore, an up and down direction is based on FIGS. 2 and 3, an upper side of these drawings being a front side and a bottom side of these drawings being a rear side.

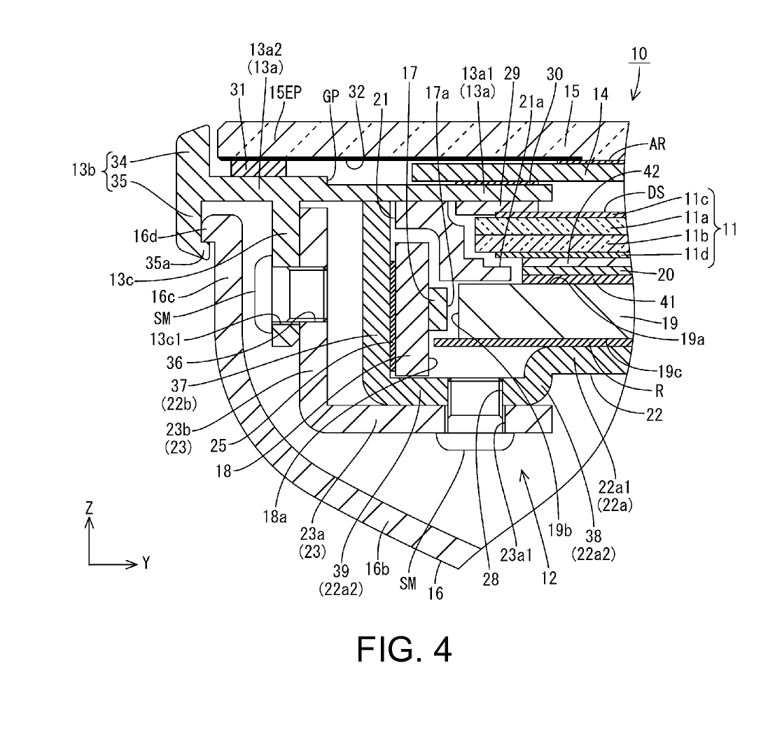

As shown in FIG. 1, the liquid crystal display device 10 has a horizontally long shape overall, being configured by attaching parts such as a touch panel 14, a cover panel (protective panel, cover glass) 15, a casing 16, and so on to a liquid crystal display unit LDU which is a base part. The liquid crystal display unit LDU has a liquid crystal panel (display panel) 11 that has a display surface DS that displays an image to the front side, a backlight device (illumination device) 12 that is disposed on the rear side of the liquid crystal panel 11 and radiates light toward the liquid crystal panel 11, and a frame (housing member) 13 that presses on the liquid crystal panel 11 from the front side, that is from a side opposite the backlight device 12 (the display surface DS side). The touch panel 14 and the cover panel 15 are inserted from the front side into the frame 13 that makes up the liquid crystal display unit LDU and an outer circumferential portion (including outer circumferential edge portions) is received from the rear side by the frame 13. The touch panel 14 is disposed in a location where a predetermined space is open in the front side with respect to the liquid crystal panel 11 and a face of the rear side (inner side) serves as an opposing face forming a state of opposition with the display surface DS. The cover panel 15 is disposed with respect to the touch panel 14 in a manner so as to overlay the front side, and the face of the rear side (inner side) serves as an opposing face forming a state of opposition with the face of the front side of the touch panel 14. Note that an anti-reflection film AR is interposed between the touch panel 14 and the cover panel 15 (see FIG. 4). The casing 16 is attached to the frame 13 in a manner so as to cover the liquid crystal display unit LDU from the rear side. Of constituent parts of the liquid crystal display device 10, part of the frame 13 (a looped portion 13b discussed below), the cover panel 15, and the casing 16 constitute an external appearance of the liquid crystal display device 10. The liquid crystal display device 10 according to the present embodiment is used mainly in electronic devices such as tablet-type notebook personal computers, a screen size thereof being around 20 inches, for example.

First, the liquid crystal panel 11 that constitutes the liquid crystal display unit LDU is described in detail. As shown in FIGS. 2 and 3, the liquid crystal panel 11 has a pair of glass substrates 11a and 11b that form a horizontally long shape, are substantially transparent, and have outstanding transparency, and a liquid crystal layer (not shown in the drawings) interposed between the substrates 11a and 11b and including liquid crystal molecules that are a substance in which optical characteristics change according to application of an electric field, the substrates 11a and 11b being adhered to each other by a sealing agent not shown in the drawings with a gap maintained which is equal to a thickness of the liquid crystal layer. The liquid crystal panel 11 has a display region in which an image is displayed (a central portion surrounded by a surface light shielding layer 32 described below), and a non-display region that forms a picture frame shape surrounding the display region and in which an image is not displayed (an outer circumferential portion that overlaps the face light shielding layer 32 described below). Note that a long-side direction in the liquid crystal panel 11 coincided with the X-axis direction, a short-side direction coincides with the Y-axis direction, and a depth direction coincides with the Z-axis direction.

Of the substrates 11a and 11b, a front side (front face side) serves as a CF substrate 11a and a rear side (rear face side) serves as an array substrate 11b. A plurality of TFTs (thin film transistors), which are switching elements, and pixel electrodes are arranged on an inner face side of the array substrate 11b (a liquid crystal layer side, a side opposing the CF substrate 11a), and gate wiring and source wiring forming a lattice shape are disposed around the TFTs and the pixel electrodes in an enclosing manner. Predetermined image signals are supplied to the wirings from a control circuit that is not shown in the drawings. The pixel electrodes disposed in a rectangular region enclosed by the gate wiring and the source wiring are constituted of transparent electrodes, such as ITO (Indium Tin Oxide) or ZnO (Zinc Oxide).

On the other hand, a plurality of color filters are arranged on the CF substrate 11a in locations corresponding to the pixels. The color filters are disposed such that three colors R, G, and B are arranged in an alternating manner. A light shielding layer (black matrix) for preventing color mixing is formed between the color filters. An opposing electrode that opposes the pixel electrodes on the array substrate 11b side is provided on the surface of the color filters and the light shielding layer. A size of the CF substrate 11a is one size smaller than the array substrate 11b. Furthermore, orientation films for orienting the liquid crystal contained in the liquid crystal layer are formed in the inner face sides of the substrates 11a and 11b. Note that polarizing plates 11c and 11d are adhered to outer face sides of the substrates 11a and 11b (see FIG. 4).

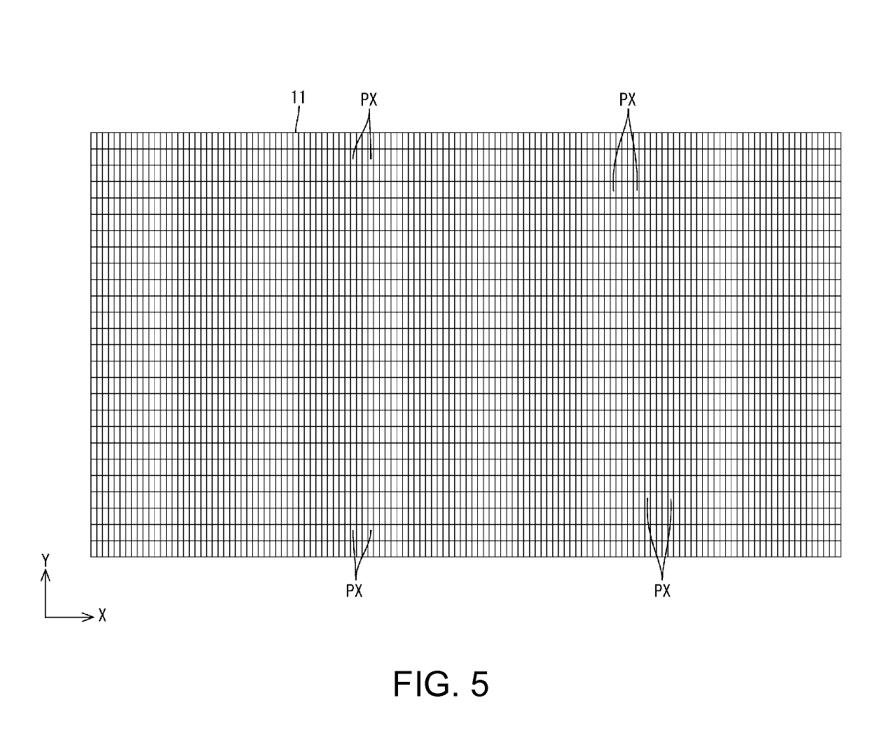

In the liquid crystal panel 11, one unit pixel PX, which is a unit of display, is made up of a set of a tricolor colored portion of R (red), G (green), and B (blue) and three of the pixel electrodes there opposing; as shown in FIG. 5, the unit pixels PX are arranged in matrix shapes (rows and columns) on the faces of the substrates 11a and 11b, that is the display surface DS (the X-axis direction and the Y-axis direction). The unit pixels PX are made up of a red pixel that has an R colored portion, a green pixel that has a G colored portion, and a blue pixel that has a B colored portion. The pixels of these colors are disposed in a repeated arrangement in the row direction (the X-axis direction) on the face of the liquid crystal panel 11 and make up pixel groups, and a plurality of these pixel groups are arranged in the column direction (the Y-axis direction). Accordingly, the unit pixels PX can be said to be periodic structures arranged in a plurality having a fixed periodicity in the X-axis direction and the Y-axis direction. Note that FIG. 5 schematically represents the arrangement of the unit pixels PX in the liquid crystal panel 11.

Next, the backlight device 12 that constitutes the liquid crystal display unit LDU is described in detail. As shown in FIG. 1, the backlight device 12 substantially forms a horizontally-long block overall, like the liquid crystal panel 11. As shown in FIGS. 3 and 4, the backlight device 12 includes an LED (Light Emitting Diode) 17 that is a light source, an LED substrate (light source substrate) 18 on which the LED 17 is mounted, a light guide plate 19 that guides light from the LED 17, an optical sheet (optical member) 20 that is laminated onto the light guide plate 19, a light shielding frame 21 that presses on the light guide plate 19 from a front side, a chassis 22 that houses the LED substrate 18, the light guide plate 19, the optical sheet 20, and the light shielding frame 21, and a heat dissipating member 23 that is attached in a manner so as to come in contact with an outer face of the chassis 22. This backlight device 12 is an edge-lit type (side-lit type) in which light is incident on one side, in which the LED 17 (LED substrate 18) is disposed on only one edge portion of a long-side side of an outer circumferential portion.

As shown in FIGS. 2 and 4, the LED 17 is configured by sealing an LED chip with a resin material onto a substrate portion affixed to the LED substrate 18. The LED chip mounted on the substrate portion has one main light emitting wavelength, specifically a single-color LED chip emitting blue light being used. On the other hand, phosphor bodies that are excited by the blue light emitted by the LED chips and emit a predetermined color are dispersed in the resin material that seals the LED, a generally white color thereby being emitted overall. Note that for the phosphor bodies it is possible to use an appropriate combination of, for example, a yellow phosphor body that emits a yellow color, a green phosphor body that emits a green color, and a red phosphor body that emits a red color, or to use one of these alone. The LED 17 is of a so-called top face light emitting type, whereby a face opposite a face mounted on the LED substrate 18 is a light-exiting surface 17a.

As shown in FIGS. 2 and 4, the LED substrate 18 has an elongated plate-shape extending in the X-axis direction (a long-side direction of the light guide plate 19 and the chassis 22), a face thereof being housed inside the chassis 22 in an attitude parallel to the X-axis direction and the Z-axis direction, that is, in an attitude orthogonal to a face of the liquid crystal panel 11 and the light guide plate 19. In other words, the attitude of the LED substrate 18 is such that the face of the long-side direction coincides with the X-axis direction, the short-side direction coincides with the Z-axis direction, and a plate-thickness direction, which is perpendicular to the face, matches the Y-axis direction. The LED substrate 18 is disposed such that the inwardly-facing face (a mounting face 18a) opposes one long-side side end face (a light-receiving face 19b) of the light guide plate 19 a predetermined distance therefrom in the Y-axis direction. Accordingly, directions of arrangement of the LED 17, the LED substrate 18, and the light guide plate 19 substantially coincide with the Y-axis direction. The LED substrate 18 has a length dimension which is substantially the same as a long-side dimension of the light guide plate 19, and is attached to one long-side side end portion of the chassis 22, described below.

As shown in FIG. 4, in the LED substrate 18, the LED 17 thus configured is mounted on the inner side, that is, on a face facing the light guide plate 19 side (a face opposing the light guide plate 19), and this is the mounting face 18a. A plurality of the LEDs 17 are arranged on the mounting face 18a of the LED substrate 18 in a length direction thereof (the X-axis direction) in a single row (linearly) predetermined distances apart. Specifically, the LEDs 17 can be said to be arranged with gaps therebetween in groups in the length direction on one long-side side end portion of the backlight device 12. A wiring pattern (not shown in the drawings) constituted of metal film (copper foil, etc.) extending in the X-axis direction and crossing the groups of the LEDs 17, thus connecting adjacent ones of the LEDs 17 in series, is formed on the mounting surface 18a of the LED substrate 18. Drive power can be supplied to the LEDs 17 because terminal portions formed at both end portions of the wiring pattern are connected to an external LED drive circuit. Furthermore, a base material of the LED substrate 18 is metal, as with the chassis 22, and the wiring pattern already discussed (not shown in the drawings) is formed on a surface thereof with an insulation layer interposed therebetween. Note that an insulation material such as ceramic can be used as a material used in a base material of the LED substrate 18.

As shown in FIGS. 2 and 3, the light guide plate 19 is made out of a synthetic resin material (e.g., acrylic, etc.) which has a greater refractive index than air and is substantially transparent (has outstanding transparency). The light guide plate 19 has a plate shape forming a horizontally long shape when viewed in a plan view, like the liquid crystal panel 11, and a face thereof is arranged in parallel with a face of the liquid crystal panel 11 (the display surface DS). In the light guide plate 19, a long-side direction in the face thereof coincides with the X-axis direction, a short-side direction coincides with the Y-axis direction, and the plate-thickness direction, which is perpendicular to the face, coincides with the Z-axis direction. The light guide plate 19 is disposed in a location directly under the liquid crystal panel 11 and the optical sheet 20 inside the chassis 22, and one long-side side end face of the outer circumferential faces thereof forms a state of opposition with the LEDs 17 of the LED substrate 18 disposed on the one long-side side end portion of the chassis 22. Accordingly, whereas the direction of arrangement of the LEDs 17 (the LED substrate 18) and the light guide plate 19 coincides with the Y-axis direction, a direction of arrangement (direction of overlap) of the optical sheet 20 (the liquid crystal panel 11) and the light guide plate 19 coincides with the Z-axis direction, these two directions of arrangement being orthogonal to each other. The light guide plate 19 has functionality whereby light emitted towards the light guide plate 19 from the LEDs 17 in the Y-axis direction (the direction of arrangement of the LEDs 17 and the light guide plate 19) enters the long side end face of the light guide plate, and that light is propagated upwards towards the optical sheet 20 side (the front surface side, the light emitting side) while being propagated internally and is emitted from the surface.

As shown in FIGS. 2 and 3, of the faces of the light guide plate 19 which form a plate shape, a face facing the surface side is a light-exiting surface 19a which causes the light inside to be emitted towards the optical sheet 20 and the liquid crystal panel 11. As shown in FIG. 4, of outer circumferential end faces adjacent to the face of the light guide plate 19, one end face (to the left in FIG. 2) of a pair of long-side side end faces forming a lengthwise shape in the X-axis direction (the direction of arrangement of the LEDs 17, the long-side direction of the LED substrate 18) forms a state of opposition with the LEDs 17 (the LED substrate 18), a predetermined gap therebetween, and this is the light-receiving face 19b into which light emitted by the LEDs 17 enters. The light-receiving face 19b is a face parallel in the X-axis direction and the Z-axis direction, and a face substantially perpendicular to the light-exiting surface 19a. Furthermore, the direction of arrangement of the LEDs 17 and the light-receiving face 19b (the light guide plate 19) coincides with the Y-axis direction, and is parallel to the light-exiting surface 19a. As shown in FIGS. 2 and 3, note that of the outer circumferential end faces of the light guide plate 19, three end faces other than the light-receiving face 19b, specifically an opposite long-side side end face and a pair of short-side side end faces are LED non-opposing end faces (light source non-opposing end faces) which do not oppose the LEDs 17.

As shown in FIGS. 2 and 3, of the end faces of the light guide plate 19, a reflective sheet R which can reflect and raise light inside the light guide plate 19 towards the surface side is provided to a face 19c on a side opposing the light-exiting surface 19a covering an entire area thereof. In other words, the reflective sheet R is disposed in a manner so as to be sandwiched between a bottom plate 22a of the chassis 22 and the light guide plate 19. As shown in FIG. 5, the end face of the reflective sheet R adjacent to a light-receiving face 19b of the light guide plate 19 extends further out than the light-receiving face 19b, that is, towards the LED 17 side, and light from the LEDs 17 is reflected by this extending portion of the reflective sheet R, thereby making it possible to improve light incidence efficiency into the light-receiving face 19b. Note that at least one or the other of the light-exiting surface 19a and the opposing face 19c in the light guide plate 19 or a surface of the reflective sheet R is patterned such that scattering portions or the like (not shown in the drawings), which cause light in the light guide plate 19 to scatter, have a predetermined in-plane distribution, and emitted light from the light-exiting surface 19a is thereby controlled so as to have a uniform distribution in-plane.

As shown in FIGS. 2 and 3, the optical sheet 20 forms a horizontally long shape seen in a plan view, like the liquid crystal panel 11 and the chassis 22. The optical sheet 20 is mounted on the light-exiting surface 19a of the light guide plate 19 and is interposed between the liquid crystal panel 11 and the light guide plate 19, thereby transmitting emitted light from the light guide plate 19, this transmitted light being emitted towards the liquid crystal panel 11 while being subject to predetermined optical effects. Note that a detailed configuration and functionality, etc., of the optical sheet 20 will be described in detail below.

As shown in FIGS. 2 and 3, the light shielding frame 21 is formed substantially in a frame shape (picture frame shape) that extends in a shape mimicking an outer circumferential portion (outer circumferential end portion) of the light guide plate 19, and can be pressed on the outer circumferential portion of the light guide plate 19 from the front side over almost the entire circumference thereof. The light shielding frame 21 is made of a synthetic resin and has light shielding properties because a surface has an aspect presenting a black color, for example. An inner end portion 21a of the light shielding frame 21 is disposed in a manner so as to be interposed along an entire circumference between the outer circumferential portion of the light guide plate 19, the LEDs 17, and outer circumferential portions (outer circumferential end portions) of the liquid crystal panel 11 and the optical sheet 20, dividing these so as to be optically independent. Light which is emitted from the LEDs 17 and does not enter the light-receiving face 19b, and light which leaks out of the end faces of the light guide plate 19 (the light-receiving face 19b and the three LED non-opposing end faces which do not oppose the LEDs 17) can be shielded from entering directly into the outer circumferential portions (end faces in particular) of the liquid crystal panel 11 and the optical sheet 20. Regarding the three sides which do not overlap the LEDs 17 and the LED substrate 18 (the pair of short-side portions and the long-side portion opposite the LED substrate 18 side) when seen in a plan view, the light shielding frame 21 has a portion that rises up from the bottom plate 22a of the chassis 22 and a portion that supports the frame 13 from a rear side, whereas the long-side portion which overlaps the LEDs 17 and the LED substrate 18 when seen in a plan view is formed so as to cover the end portion of the light guide plate 19 and the LED substrate 18 (the LEDs 17) from the front side and to bridge the pair of short-side portions. The light shielding frame 21 is affixed to the chassis 22, which is described next, with an affixing member such as screw members or the like not shown in the drawings.

As shown in FIGS. 2 and 3, the chassis 22 is made of a metal plate with outstanding heat conductivity, such as for example an aluminum plate or an electrogalvanized steel plate (SECC), and is constituted of the bottom plate 22a which forms a horizontally long shape like the liquid crystal panel 11, and side plates 22b that rise up towards the front side from outer ends of each side (a pair of long sides and a pair of short sides) of the bottom plate 22a. In the chassis 22 (the bottom plate 22a) a long-side direction coincides with the X-axis direction and a short-side direction coincides with the Y-axis direction. The bottom plate 22a is such that a majority thereof is a light guide plate supporting portion 22a1 that supports the light guide plate 19 from the rear side (the side opposite the light-exiting surface 19a side), while an end portion on the LED substrate 18 side is a substrate housing portion 22a2 which bulges towards the rear side in a step-like shape. As shown in FIG. 4, the substrate housing portion 22a2 has a substantially L-shaped cross-sectional shape, and includes a rising portion 38 that curves from an end portion of the light guide plate supporting portion 22a1 and rises towards the front side, and a housing bottom portion 39 that curves from a rising tip end portion of the rising portion 38 and protrudes towards a side opposite the light guide plate supporting portion 22a1 side. A location of the curve from the end portion of the light guide plate supporting portion 22a1 in the rising portion 38 is located closer to a side opposite the LEDs 17 from the light-receiving face 19b of the light guide plate 19 (towards a center of the light guide plate supporting portion 22a1). The long-side side plates 22b are formed curved so as to rise towards the front side from the protruding tip end portion of the housing bottom portion 39. The LED substrate 18 is attached to the long-side side plates 22b that are linked to the substrate housing portion 22a2, and these side plates 22b constitute a substrate attachment portion 37. The substrate attachment portion 37 has an opposing face which forms a state of opposition with the light-receiving face 19b of the light guide plate 19, and the LED substrate 18 is attached to this opposing face. In the LED substrate 18, a face opposite the mounting face 18a onto which the LEDs 17 are mounted is affixed to the inner face of the substrate attachment portion 37 in a manner so as to be in contact with a substrate affixing member 25, such as double-sided tape, interposed therebetween. There is a narrow space between the LED substrate 18 thus attached and the inner face of the housing bottom portion 39 which forms the substrate housing portion 22a2. Furthermore, a liquid crystal panel drive circuit substrate (not shown in the drawings) for controlling driving of the liquid crystal panel 11, an LED drive circuit substrate (not shown in the drawings) that supplies drive power to the LEDs 17, a touch panel drive circuit substrate (not shown in the drawings) for controlling driving of the touch panel 14, and so on are attached to a rear face of the bottom plate 22a of the chassis 22.

As shown in FIGS. 1 and 2, the heat dissipating member 23 is made of a metal plate with outstanding heat conductivity, such as an aluminum plate, and extends along a long-side side end portion of the chassis 22, specifically the substrate housing portion 22a2 that houses the LED substrate 18. As shown in FIG. 4, the heat dissipating member 23 has a substantially L-shaped cross-sectional shape, and is constituted of a first heat dissipating portion 23a that is parallel to an outer surface of the substrate housing portion 22a2 and in contact with an outer face thereof, and a second heat dissipating portion 23b that is parallel to outer faces of the side plates 22b (the substrate attachment portion 37) that are linked to the substrate housing portion 22a2. The first heat dissipating portion 23a forms a long, narrow plate shape extending in the X-axis direction, and faces facing the front side parallel to the X-axis direction and the Y-axis direction abut almost an entire length of an outer face of the housing bottom portion 39 in the substrate housing portion 22a2. The first heat dissipating portion 23a is screwed into the housing bottom portion 39 by screw members SM, and has screw insertion through-holes 23a1 into which the screw members SM are inserted. Furthermore, screw holes 28 in which the screw members SM are screwed are formed in the housing bottom portion 39. Heat emitted by the LEDs 17 is thus transmitted to the first heat dissipating portion 23a via the LED substrate 18, the substrate attachment portion 37, and the substrate housing portion 22a2. Note that the screw members SM are attached so as to be arranged in gapped groups in a direction of extension of the first heat dissipating portion 23a. The second heat dissipating portion 23b forms a long, narrow plate shape that extends in the X-axis direction, and faces facing inward that are parallel to the X-axis direction and the Z-axis direction are disposed in an opposing state, a predetermined distance away from an outer face of the substrate attachment portion 37.

The frame 13 that makes up the liquid crystal display unit LDU is described next. As shown in FIG. 1, the frame 13 is made out of a metal material that has outstanding heat conductivity, such as aluminum, and substantially forms overall a horizontally-long frame shape (picture frame shape) that extends in a shape mimicking the outer circumferential portions (outer circumferential end portions) of the liquid crystal panel 11, the touch panel 14, and the cover panel 15. Press machining or the like is adopted as a method for manufacturing the frame 13, for example. As shown in FIGS. 2 and 3, the frame 13 presses on the outer circumferential portions of the liquid crystal panel 11 from the front side and, in a sandwiching manner with the chassis 22 that forms a portion of the backlight device 12, holds the liquid crystal panel 11, the optical sheet 20, and the light guide plate 19, which are laminated together. On the other hand, the frame 13 receives outer circumferential portions of the touch panel 14 and the cover panel 15 from the rear side, and is disposed so as to be interposed between the outer circumferential portions of the liquid crystal panel 11 and the touch panel 14. A predetermined gap is thus ensured between the liquid crystal panel 11 and the touch panel 14, and therefore even in a case in which the touch panel 14 follows the cover panel 15 and deforms so as to bend towards the liquid crystal panel 11 side when an outside force acts on the cover panel 15, for example, the touch panel 14 thus bent does not readily interfere with the liquid crystal panel 11.

As shown in FIGS. 2 and 3, the frame 13 has a frame portion (frame base portion, picture frame portion) 13a that mimics the outer circumferential portions of the liquid crystal panel 11, the touch panel 14, and the cover panel 15, an looped portion (tubular portion) 13b that is connected to an outer circumferential end portion of the frame portion 13a and surrounds the touch panel 14, the cover panel 15, and the casing 16 from an outer circumferential side thereof, and an attachment plate portion 13c that protrudes from the frame portion 13a towards the rear side and is attached to the chassis 22 and the heat dissipating member 23.

As shown in FIGS. 2 and 3, the frame portion 13a substantially forms a plate shape having faces parallel to faces of the liquid crystal panel 11, the touch panel 14, and the cover panel 15, and is formed in a frame shape that is horizontally long and substantially rectangular when seen in a plan view. In the frame portion 13a, an outer circumferential portion 13a2 has a relatively thicker plate thickness than an inner circumferential portion 13a1, and a step (gap) GP is formed in a boundary location between the two. In the frame portion 13a, the inner circumferential portion 13a1 is interposed between an outer circumferential portion of the liquid crystal panel 11 and an outer circumferential portion of the touch panel 14, whereas the outer circumferential portion 13a2 receives the outer circumferential portion of the cover panel 15 from the rear side. Thus, a front side face of the frame portion 13a is almost completely covered by the cover panel 15, and therefore the front side face is not exposed to the outside almost completely. A user of the liquid crystal display device 10 thus does not readily come in contact with exposed sites in the frame 13, enhancing safety, even if a temperature of the frame 13 rises due to heat, etc., from the LEDs 17. A buffering material 29 for buffering and pressing on the outer circumferential portion f the liquid crystal panel 11 from the front side is affixed to the rear side face of the inner circumferential portion 13a1 of the frame portion 13a, whereas a first affixing member 30 for buffering and affixing an outer circumferential portion of the touch panel 14 is affixed to a front side face of the inner circumferential portion 13a1. The buffering material 29 and the first affixing member 30 are disposed to mutually overlaying locations when seen in a plan view in the inner circumferential portion 13a1. On the other hand, a second affixing member 31 for buffering and affixing the outer circumferential portion of the cover panel 15 is affixed to the front side face of the outer circumferential portion 13a2 of the frame portion 13a. The buffering material 29 and the affixing members 30 and 31 are disposed in a manner so as to extend along side portions of the frame portion 13a other than four corner portions. The affixing members 30 and 31 include double-sided tape in which a base material has cushioning characteristics, for example.

As shown in FIGS. 2 and 3, the looped portion 13b forms a horizontally long rectangular short-angle tubular form overall when seen in a plan view, and has a first looped portion 34 that protrudes from an outer circumferential edge of the outer circumferential portion 13a2 of the frame portion 13a towards the front side, and a second looped portion 35 that protrudes from the outer circumferential edge of the outer circumferential portion 13a2 of the frame portion 13a towards the rear side. In other words, in the looped portion 13b that forms a short-angle tubular shape, the outer circumferential edge of the frame portion 13a is connected along an entire circumference to an inner circumferential face in a substantially central portion in an axial line direction thereof (the Z-axis direction). The first looped portion 34 is disposed in a manner so as to surround along an entire circumference the outer circumferential faces of the touch panel 14 and the cover panel 15 disposed on the front side with respect to the frame portion 13a. An inner circumferential face of the first looped portion 34 forms a state of opposition with the outer circumferential faces of the touch panel 14 and the cover panel 15, whereas an outer circumferential face is exposed to the outside of the liquid crystal display device 10 and constitutes a lateral face side external appearance of the liquid crystal device 10. On the other hand, the second looped portion 35 surrounds from an outer circumferential side a front side end portion (attachment portions 16c) of the casing 16 that is disposed on the rear side with respect to the frame portion 13a. An inner circumferential face of the second looped portion 35 forms a state of opposition with the attachment portions 16c of the casing 16 that are discussed below, whereas an outer circumferential face is exposed to the outside of the liquid crystal display device 10 and constitutes a lateral face side external appearance of the liquid crystal device 10. A frame side engaging claw portion 35a forming a cross-sectional hook form is formed on a protruding tip end portion of the second looped portion 35, and the casing 16 is engaged by the frame side engaging claw portion 35a, thereby making it possible to hold the casing 16 in an engaged state.

As shown in FIGS. 2 and 3, the attachment portions 13c protrude from the outer circumferential portion 13a2 of the frame portion 13a towards the rear side and form a plate shape extending along the side portions of the frame portion 13a, and faces thereof are substantially orthogonal to the face of the frame portion 13a. The attachment portions 13c are individually disposed on each of the side portions of the frame portion 13a. In the frame portion 13a, the attachment plate portion 13c that is disposed on the long side portion of the LED substrate 18 side is attached in a manner such that a face thereof facing inward is in contact with an outer face in the second heat dissipating portion 23b of the heat dissipating member 23. The attachment plate portion 13c is screwed into the second heat dissipating portion 23b by the screw members SM, and has screw insertion through-holes 13c1 in which the screw members SM are inserted. Furthermore, screw holes 36 into which the screw members MS are screwed are formed in the second heat dissipating portion 23b. Heat from the LEDs 17 that is transmitted from the first heat dissipating portion 23a to the second heat dissipating portion 23b is thereby transmitted to the attachment plate portion 13c and then transmitted to the entire frame 13, heat thereby being efficiently released. Furthermore, the attachment plate portion 13c is indirectly affixed to the chassis 22 with the heat dissipating member 23 interposed therebetween. On the other hand, the attachment plate portions 13c disposed on the long-side portion opposite the LED substrate 18 side and the pair of short-side portions in the frame portion 13a are screwed in by the screw members SM in a manner such that inwardly-facing faces thereof are in contact with outer faces of the side plates 22b of the chassis 22. The screw insertion holes 13c1 into which the screw members SM are inserted are formed in the attachment plate portions 13c, whereas the screw holes 36 in which the screw members are screwed are formed in the side plates 22b. Note that the screw members SM are attached in a manner so as to be arranged in gapped groups in directions of extension of the attachment plate portions 13c.

The touch panel 14 which is attached to the frame 13 is described next. As shown in FIGS. 1 to 3, the touch panel 14 is a position input device for the user to input position data in-plane in the display face DS of the liquid crystal panel 11, and a predetermined touch panel pattern (not shown in the drawings) is formed on a glass substrate that forms a horizontally long rectangular shape, is substantially transparent, and has outstanding transparency. Specifically, the touch panel 14 has the glass substrate that forms a horizontally long rectangular shape like the liquid crystal panel 11, touch panel transparent electrode portions (not shown in the drawings) that constitute a so-called projection-type electrostatic capacitance touch panel is formed in a face thereof that faces toward the front side, and the touch panel transparent electrode portions are arranged in matrix shapes in the face of the substrate. Terminal portions (not shown in the drawings) that are connected to end portions of wiring that is led out from the touch panel transparent electrode portions constituting the touch panel pattern are formed in one long-side side end portion of the touch panel 14, and a flexible substrate that is not shown in the drawings is connected to these terminal portions, electrical potential thereby being supplied from the touch panel drive circuit substrate to the touch panel transparent electrode portion that forms the touch panel pattern. An inside face of an outer circumferential portion of the touch panel 14 is affixed in an opposing state to the inner circumferential portion 13a1 of the frame portion 13a of the frame 13 by the aforementioned first affixing member 30.

The cover panel 15 that is attached to the frame 13 is described next. As shown in FIGS. 1 to 3, the cover panel 15 is disposed in a manner so as to entirely cover the touch panel 14 from the front side, the touch panel 14 and the liquid crystal panel 11 thereby being protected. The cover panel 15 covers the entire frame portion 13a of the frame 13 from the front side and constitutes a frontal external appearance of the liquid crystal display device 10. The cover panel 15 is a plate-shaped base material made out of glass that forms a horizontally long rectangular shape, is substantially transparent, and has outstanding translucency, and preferably includes reinforced glass. Chemically reinforced glass provided with a chemical reinforcement layer on a surface by applying a chemical reinforcement process on a surface of a plate-shaped glass base material, for example, is preferably used as the reinforced glass used in the cover panel 15. This chemical reinforcement process is, for example, a process that reinforces a plate-shaped glass base material by substituting alkali metal ions contained in the glass material with alkali metal ions having a larger ion radius there than through ion exchange, and the chemically reinforced layer formed as a result serves as a compression stress layer (ion exchange layer) with residual compression stress. The cover panel 15 thus has high mechanical strength and shock-resistance performance, and therefore it is possible to more surely prevent the touch panel 14 and the liquid crystal panel 11 disposed on a rear side thereof from breaking or getting scratched.

As shown in FIGS. 2 and 3, the cover panel 15 forms a horizontally long rectangular shape when seen in a plan view, like the liquid crystal panel 11 and the touch panel 14, and a size thereof when seen in a plan view is one size larger than the liquid crystal panel 11 and the touch panel 14. Accordingly, the cover panel 15 has a projected portion 15EP that projects outward as a cover from outer circumferential edges around entire circumferences of the liquid crystal panel 11 and the touch panel 14. The projected portion 15EP substantially forms a horizontally long rectangular frame shape (substantial picture frame shape) that surrounds the liquid crystal panel 11 and the touch panel 14, and an inside face thereof is affixed in a state of opposition to the outer circumferential portion 13a2 in the frame portion 13a of the frame 13 by the second affixing member 31 described above. On the other hand, a central portion of the cover panel 15 forming a state of opposition with the touch panel 14 is laminated on the front side to the touch panel 14 with the anti-reflection film AR interposed therebetween.

As shown in FIGS. 2 and 3 the surface light shielding layer (light shielding layer, face light shielding portion) 32 is formed on a face (a face facing the touch panel 14 side) of the inside (rear side) of the circumferential portion of the cover panel 15 including the projected portion 15EP. The surface light shielding layer 32 is a light shielding material such as paint or the like that presents a black color, for example, and this light shielding material is provided integrally to a face by being printed on the inside face of the cover panel 15. Note that when providing the surface light shielding layer 32, a printing means such as screen printing, ink jet printing, or the like, for example, can be adopted. In addition to an entire area of the projected portion 15EP in the cover panel 15, the surface light shielding layer 32 is formed in an area further inside than the projected portion 15EP, covering portions overlapping with the outer circumferential portions of the touch panel 14 and the liquid crystal panel 11 when seen in a plan view. Accordingly, the surface light shielding layer 32 is disposed in a manner so as to surround a display region of the liquid crystal panel 11, and can therefore shield light outside the display region, thereby being able to achieve high display quality for images displayed in the display region.

The casing 16 attached to the frame 13 is described next. As shown in FIGS. 1 to 3, the casing 16 is made out of a synthetic resin material or a metal material, and substantially forms a bowl shape (a substantial bowl shape) open towards the front side, covers the frame portion 13a of the frame 13, the attachment plate portions 13c, the chassis 22, the heat dissipating member 23, and other members from the rear side, and constitutes an external appearance of a back side of the liquid crystal display device 10. The casing 16 includes a generally flat bottom portion 16a, a curved portion 16b that rises up towards the front side from an outer circumferential edge of the bottom portion 16a and forms a cross-sectionally curved shape, and an attachment portion 16c that rises substantially vertically upward towards the front side from the outer circumferential edge of the curved portion 16b. A casing side engaging claw portion 16d forming a cross-sectional hook shape is formed in the attachment portion 16c, and the casing 16 can be held onto the frame 13 in an attached state by the casing side engaging claw portion 16d being engaged by the frame side engaging claw portion 35a of the frame 13.

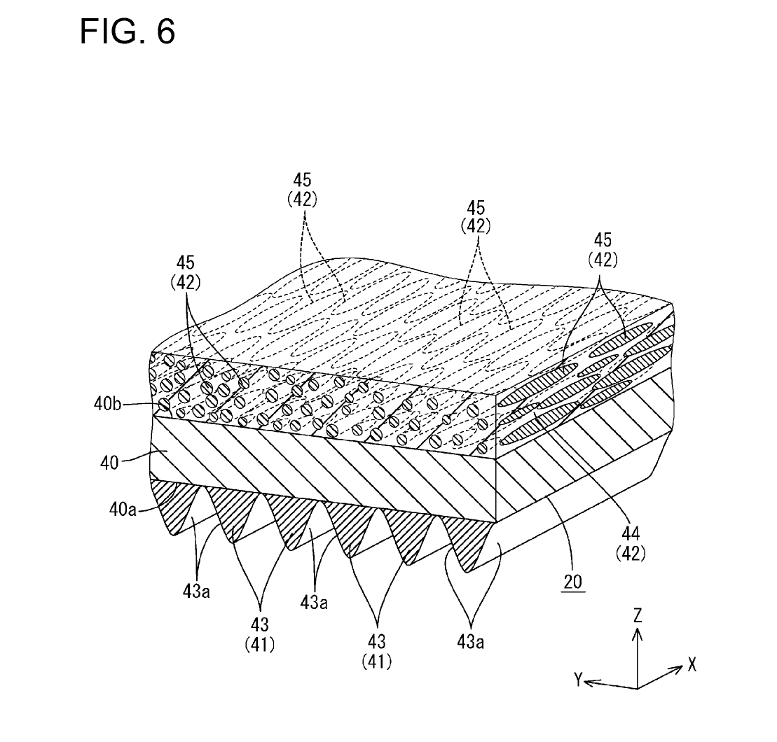

The optical sheet 20 is described in detail once more here. The optical sheet 20 can improve frontal luminance of emitted light supplied to the liquid crystal panel 11 and mitigate directionality which can occur in the emitted light by applying a predetermined diffusion action on emitted light from the light guide plate 19 after a predetermined light focusing action has been applied. As shown in FIG. 6, the optical sheet 20 is configured by a base material 40 that forms a sheet shape, an anisotropic light focusing part 41 that is formed on a light-receiving surface 40a where light from the light guide plate 19 enters into the base material 40 and that has light focusing anisotropy, and an anisotropic light diffusing part 42 that is formed on an light exiting surface 40b where light is emitted towards the liquid crystal panel 11 in the base material 40 and that has light diffusion anisotropy. A haze value of the optical sheet 20 according to the present embodiment having the anisotropic light focusing part 41 and the anisotropic light diffusing part 42 is around 50% to 80%, for example.

As shown in FIG. 6, the base material 40 forms a sheet shape that is substantially transparent and has outstanding translucency, and includes a thermoplastic resin material such as PET. When manufacturing the optical sheet 20, the base material 40 is molded, for example, by forming the thermoplastic resin material making up the base material 40 as a film of a predetermined thickness and subjecting the film to biaxial stretching in the X-axis direction and the Y-axis direction in a high-temperature environment. In the base material 40 thus molded, molecules of the thermoplastic resin material are oriented in the stretching directions (the X-axis direction and the Y-axis direction) during the manufacturing process, high strength and high heat-resistance thereby being obtained. Furthermore, a thickness of the base material 40 is around 25 μm to 100 μm, for example.

As shown in FIGS. 6, 7, and 9, the anisotropic light focusing part 41 is a face on the rear side of the base material 40, and is integrally provided to the light-receiving surface 40a into which light emitted by the light-exiting surface 19a enters by opposing the light-exiting surface 19a of the light guide plate 19. The anisotropic light focusing part 41 includes an ultraviolet ray curing resin material that is substantially transparent and is one type of light curing resin material. The ultraviolet light curing resin material has as a main ingredient a substantially transparent resin material such as acrylic resin, for example, and has properties of curing (viscosity increasing, thickening) under ultraviolet rays (UV light), and a refractive index thereof is greater than air, being generally around the same as the refractive index of the light guide plate 19. When manufacturing the optical sheet 20, a molding die is filled with the ultraviolet ray curing resin material that is uncured, for example, the base material 40 is placed against an open end of the die, thereby disposing the uncured ultraviolet ray curing resin material in a manner so as to be in contact with the light-receiving surface 40a, and the ultraviolet ray curing resin material is irradiated with ultraviolet rays with the base material 40 interposed therebetween in this state, thereby making it possible to form the anisotropic light focusing part 41 by curing the ultraviolet ray curing resin material. A thickness of the anisotropic light focusing part 41 (a height dimension of prisms 43 described below) is approximately 10 μm to 20 μm, for example.

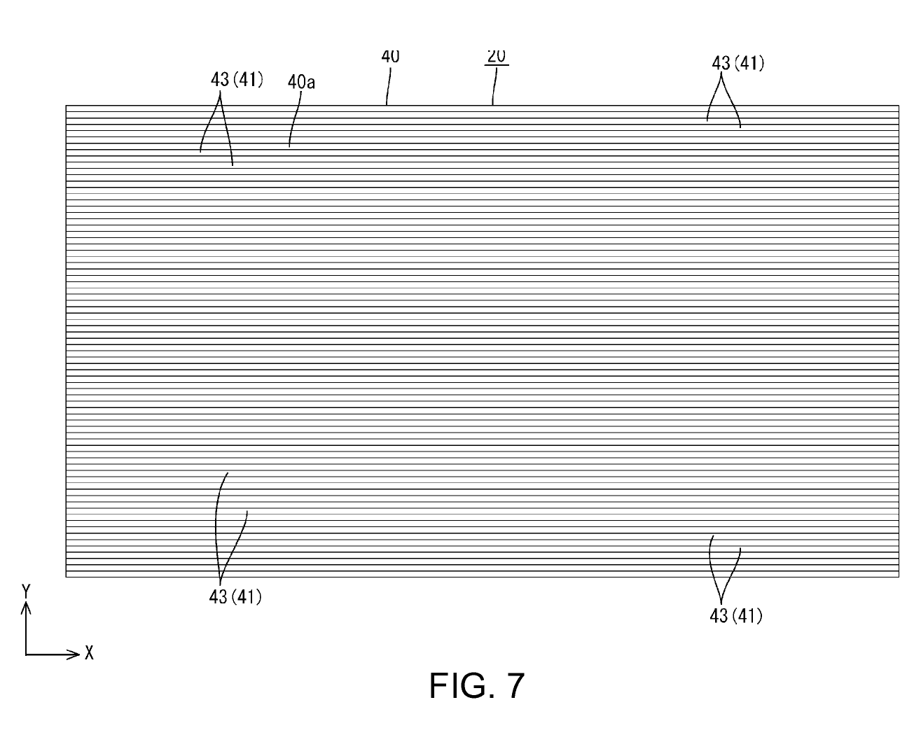

As shown in FIGS. 6, 7, and 9, the anisotropic light focusing part 41 is configured by a plurality of the prisms 43 that protrude towards the rear side (the light guide plate 19 side) in the Z-axis direction from the light-receiving surface 40a of the base material 40. The prisms 43 are such that a cross-sectional shape cut in the Y-axis direction (the direction of arrangement of the LEDs 17 and the light guide plate 19) thereof is substantially ridge-shaped, extend linearly in the X-direction (a direction along the face (the light-exiting surface 19a) of the light guide plate 19 and orthogonal to the direction of arrangement of the LEDs 17 and the light guide plate 19), and are arranged in a plurality in the Y-axis direction in the light-receiving surface 40a. The prisms 43 are such that the cross-sectional shape thereof is substantially an isosceles triangle shape, having a pair of slanted faces 43a on either side of an apex. The prisms 43 have an acute apex angle, and the slanted faces 43a form a slanted shape with respect to the Y-axis direction and the Z-axis direction and extend in the X-axis direction while maintaining a fixed angle of inclination. Accordingly, the angle of inclination of the slanted faces 43a is fixed in all locations along the X-axis direction, which is a direction of extension of the prisms 43. The plurality of prisms 43 arranged in the Y-axis direction are such that an apex angle, a width dimension of a bottom side, and a height dimension are all substantially identical, and an arrangement interval between adjacent ones of the prisms 43 is arranged substantially fixed and at equal intervals. The prisms 43 are such that the apex angle is around 60° to 90°, for example, and such that the width dimension (an arrangement interval of the prisms 43) of the bottom side is around 15 μm to 35 μm, for example. Note that FIG. 7 schematically represents an arrangement of prisms 43 in the optical sheet 20.

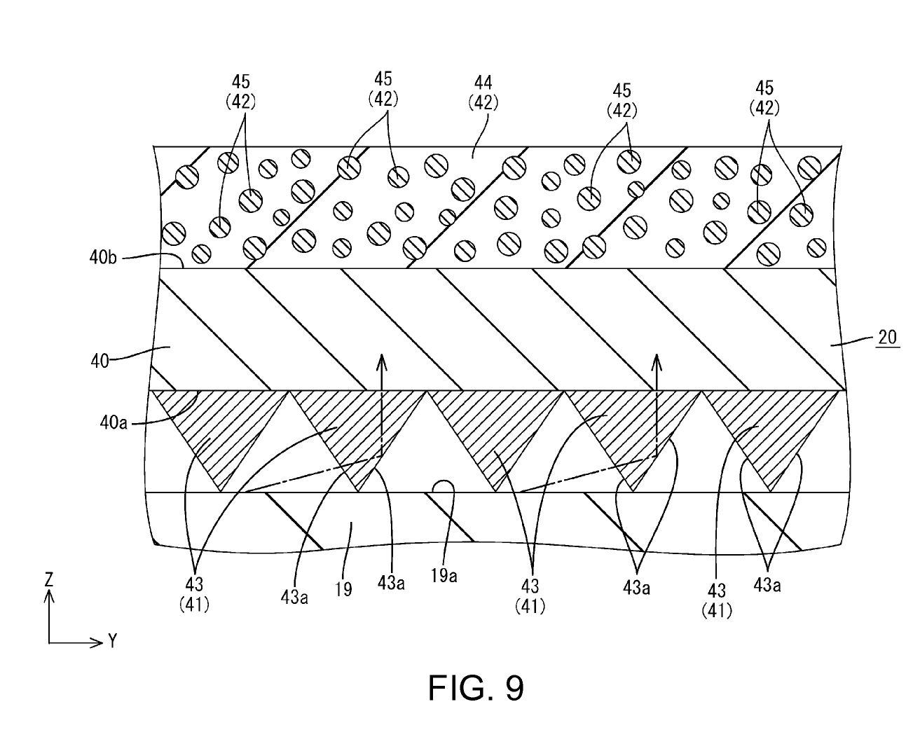

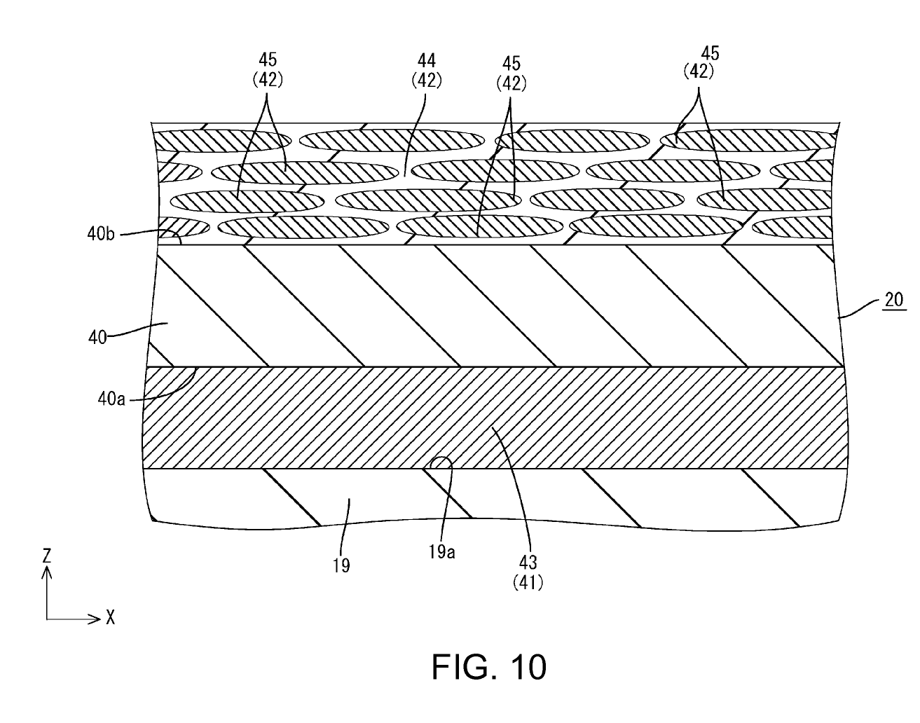

As shown in FIGS. 9 and 10, when light enters the prisms 43 having this configuration from the light guide plate 19 side, the light entering the prisms 43 is refracted by a boundary between the slanted faces 43a and an outside air layer, thereby rising towards a frontal direction (a direction of a normal with respect to the faces 40a and 40b of the base material 40). Here, light propagated inside the light guide plate 19 and light emitted from the light-exiting surface 19a mostly moves in a direction from the LEDs 17 towards the light guide plate 19 (to the right in the Y-axis direction in FIG. 4), making it possible to improve the frontal luminance of the light supplied from the optical sheet 20 to the liquid crystal panel 11 by efficiently raising the light towards the frontal direction by the prisms 43. Although this type of light focusing action acts on light entering the prisms 43 in the Y-axis direction, that is, in the direction of arrangement of the LEDs 17 and the light guide plate 19, light entering in the X-axis direction, which is orthogonal to the Y-axis direction, is almost completely not acted upon. Accordingly, in the anisotropic light focusing part 41 according to the present embodiment, whereas the Y-axis direction, which is the direction of arrangement of the plurality of prisms 43 is a direction of light focusing in which the light focusing action is applied to the light, the X-axis direction, which is the direction of extension of the prisms 43, is a non-light focusing direction, in which the light focusing action acts on the light almost not at all. The anisotropic light focusing part 41 is thus a periodic structure and has properties of selectively focusing light in a particular direction, that is, has anisotropic properties.

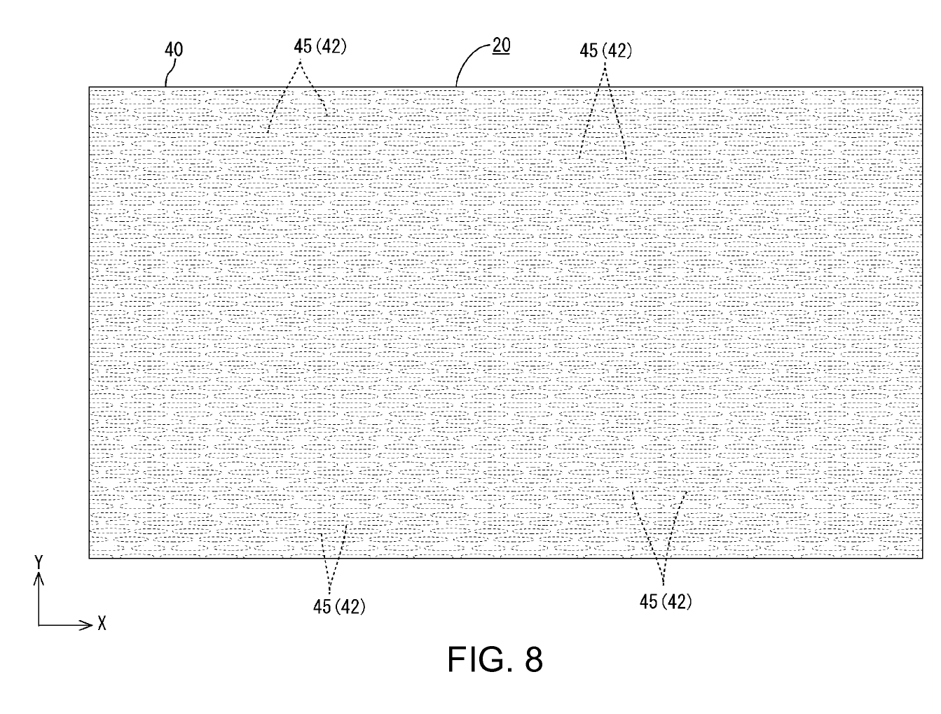

As shown in FIGS. 6 and 8, the anisotropic light diffusing part 42 is a front side face of the base material 40, and is integrally provided to the light exiting surface 40b where light that has been subject to the light focusing action by the anisotropic light focusing part 41 and light which has not been subject to the light focusing action passes through the base material 40 and is emitted. The light exiting surface 40b and the anisotropic light diffusing part 42 form a state of opposition with the liquid crystal panel 11 that is disposed on the front side. Furthermore, the anisotropic light diffusing part 42 is such that a thickness dimension is thinner than the base material 40, and is specifically around 10 μm to 20 μm, for example. The anisotropic light diffusing part 42 is provided with a transparent resin layer 44 that is laminated on the light exiting surface 40b in the base material 40 and forms a film with a predetermined thickness, and anisotropic light diffusing particles (elongated filler) 45 that are dispersed and mixed into the transparent resin layer 44 in a plurality. Of these, the transparent resin layer 44 has as main ingredient a resin material that is substantially transparent and has outstanding translucency, such as, for example, acrylic resin, polyurethane, polyester, silicone resin, epoxy resin, an ultraviolet ray curing resin, or the like. When manufacturing the optical sheet 20, the transparent resin layer 44 containing the anisotropic light diffusing particles 45 can be laminated and formed integrally on the base material 40 by adding a solvent or the like to the resin material that is the main ingredient of the transparent resin layer 44 thereby achieving a liquid state, dispersing and mixing a plurality of the anisotropic light diffusing particles 45 into the liquid, applying the liquid in a predetermined direction on the light exiting surface 40b of the base material 40, and then solidifying the liquid. The transparent resin layer 44 is such that a refractive index is around 1.3 to 1.6, for example.

As shown in FIGS. 6 and 8, the anisotropic light diffusing particles 45 are dispersed and mixed into the transparent resin layer 44 described above in a plurality, and are oriented so as to have a specific attitude. The anisotropic light diffusing particles 45 are, for example, a resin material that is substantially transparent and has outstanding translucency, such as an inorganic material such as silica, aluminum hydroxide, zinc oxide, or the like or an organic material such as acrylic resin, polyurethane, polystyrene, or the like, and a refractive index thereof is around 1.3 to 1.6, for example. Furthermore, a weight ratio of the anisotropic light diffusing particles 45 to the transparent resin layer 44 is, for example, around 10 wt. % to 40 wt. %. The anisotropic light diffusing particles 45 form an elongated shape that has a long-axis direction and a short-axis direction, and are formed overall in a substantially elliptical shape. Specifically, the anisotropic light diffusing particles 45 are such that a cross-sectional shape cut along the long-axis direction is an elliptical shape, whereas a cross-sectional shape cut along the short-axis direction is a circular shape, and form a diminishing shape in the long-axis direction from a central side to both end sides. Accordingly, both end portions of the anisotropic light diffusing particles 45 have rounded shapes in the long-axis direction. The anisotropic light diffusing particles 45 have a symmetrical shape along the short-axis direction and along an axis of symmetry passing through a central position in the long-axis direction. Furthermore, the anisotropic light diffusing particles 45 are such that a length dimension along the long-axis direction thereof is around 10 μm, for example, where as a maximum width dimension and a maximum diameter dimension in the short-axis direction is around 2 μm, for example, actual sizes of these dimensions slightly varying randomly for each of the anisotropic light diffusing particles 45.

As shown in FIGS. 6, 8, and 10, the anisotropic light diffusing particles 45 that are dispersed and mixed in the transparent resin layer 44 in a plurality are oriented so as to have an attitude whereby the long-axis direction thereof is along the X-axis direction and the short-axis direction is along the Y-axis direction. In other words, the anisotropic light diffusing particles 45 are generally arranged in an attitude (configuration) having a particular directionality, namely such that the long-axis direction is parallel to the direction of extension of the prisms 43 that the anisotropic light focusing part 41 has and the non-light focusing direction of the prisms 43, whereas the short-axis direction is parallel to the direction of arrangement of the prisms 43 that the anisotropic light focusing part 41 has and the light focusing direction of the prisms 43. The anisotropic light diffusing particles 45 are held in the aforementioned attitude by the transparent resin layer 44 that fills an area therearound. Note that not all of the plurality of the anisotropic light diffusing particles 45 that are present in the transparent resin layer 44 necessarily acquire an attitude that perfectly matches the attitude described above, and it is not a problem if some are included that have an attitude whereby the long-axis direction is slightly tilted away from the X-axis direction or the short-axis direction is slightly tilted away from the Y-axis direction. Although the plurality of the anisotropic light diffusing particles 45 are oriented in the aforementioned attitude, an arrangement in the X-axis direction, the Y-axis direction, and the Z-axis direction within transparent resin layer 44 (distance therebetween, etc.) is random (irregular), and the anisotropic light diffusing particles 45 can be called non-periodic structures that do not have periodicity, like unit pixels PX that the liquid crystal panel 11 has.

When manufacturing the optical sheet 20, a solvent or the like is added to the resin material that forms the transparent resin layer 44, thereby achieving a liquid state, a plurality of the anisotropic light diffusing particles 45 are dispersed and mixed in the liquid, and this liquid is applied in the X-axis direction to the light exiting surface 40b in the base material 40. An orientation of the anisotropic light diffusing particles 45, that have an elongated shape, is thus automatically aligned such that the long-axis direction is in a direction of application due to a shearing force in effect during application (see FIGS. 6, 9, and 10). Accordingly, by making the direction of application coincide with the X-axis direction, the long-axis direction of the anisotropic light diffusing particles 45 can easily be oriented so as to be in the non-light focusing direction and the short-axis direction so as to be in the light focusing direction. At this time, the orientation of the anisotropic light diffusing particles 45 is smoothly aligned during application, since the cross-sectional shape that diminishes and is cut along the long-axis direction forms an elliptical shape and the cross-sectional shape cut along the short-axis direction forms a circular shape. Once the liquid applied to the base material 40 is solidified, the transparent resin layer 44 is laminated on the light exiting surface 40b of the base material 40, and the plurality of the anisotropic light diffusing particles 45 contained therein are held in a state oriented in an attitude in which the long-axis direction is in the X-axis direction and the short-axis direction is in the Y-axis direction.

When light supplied from the rear side, that is from the anisotropic light focusing part 41 side, hits the anisotropic light diffusing particles 45, which have the aforementioned shape and orientation, the light is diffused and emitted to the front side, and, as shown in FIGS. 6, 9, and 10, a diffused light intensity thereof is relatively greater in the short-axis direction (the Y-axis direction) and relatively lower in the long-axis direction (the X-axis direction). Accordingly, the anisotropic light diffusing part 42 according to the present embodiment have light diffusion anisotropy whereby the Y-axis direction, which is the short-axis direction of the anisotropic light diffusing particles 45, is a strong light diffusion direction in which a strong light diffusion action is applied by the light, and the X-axis direction, which is the long-axis direction of the anisotropic light diffusing particles 45, is a weak light diffusion direction in which a the light diffusion action applied to the light is weak. In the anisotropic light diffusing part 42, the strong light diffusion direction coincides with the light focusing direction of the anisotropic light focusing part 41 and the weak light diffusion direction coincides with the non-light focusing direction of the anisotropic light focusing part 41. For light that is subject to the light focusing action by the anisotropic light focusing part 41, diffusion is thus promoted by the anisotropic light diffusing part 42, while for light which was not subject to the light focusing action by the anisotropic light focusing part 41, diffusion can be suppressed by the anisotropic light diffusing part 42, and therefore directionality which occurs caused by the light focusing action of the anisotropic light focusing part 41 can be appropriately mitigated in light supplied by the optical sheet 20 to the liquid crystal panel 11.

Moreover, the plurality of the anisotropic light diffusing particles 45 that make up the anisotropic light diffusing part 42 are oriented in the aforementioned attitude and randomly disposed in the transparent resin layer 44, and therefore emitted light can be randomly diffused and directionality of the emitted light can be appropriately mitigated. In addition to that, the anisotropic light diffusing particles 45 that are disposed randomly are a non-periodic structure, and therefore interference occurs less readily with an arrangement of the unit pixel PX (see FIG. 5) of the liquid crystal panel 11 to which the emitted light is supplied, occurrence of interference stripes called moiré thereby being suppressed in the liquid crystal panel 11.

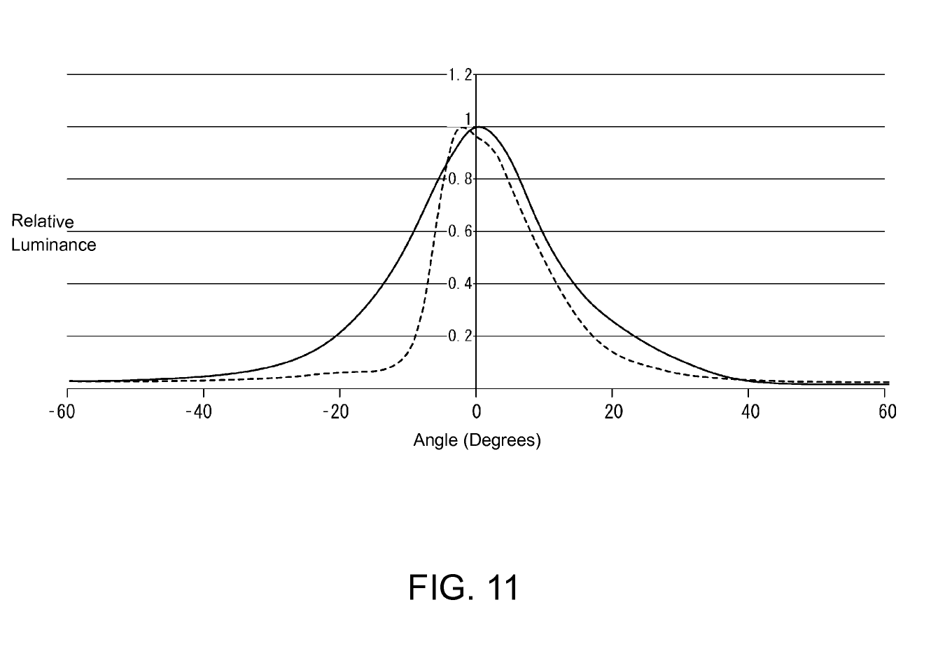

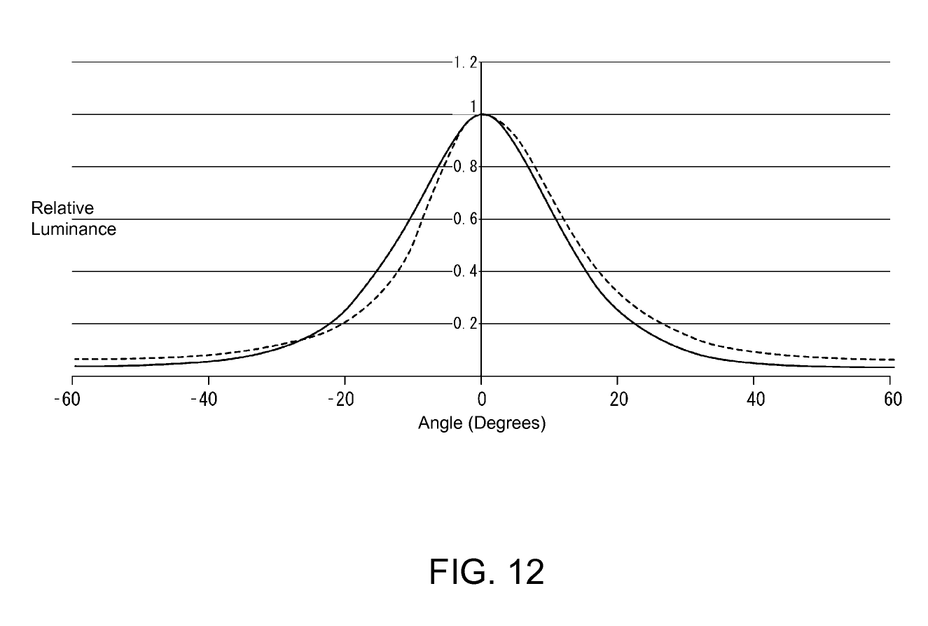

A comparison experiment between the optical sheet 20 according to the present embodiment and a prism sheet (not shown in the drawings) provided with the anisotropic light diffusing part 42 as in the present embodiment is described next. In this comparison experiment, the backlight device 12 using the optical sheet 20 according to the present embodiment is used as an example, while a backlight device in which an anisotropic light focusing part similar to the present embodiment is provided to a light incidence side face of a base material, but a prism sheet is used in which a light emitting side face of the base material has a flat shape and which does not have an anisotropic light diffusing part is used as a comparison example, and luminance of emitted light from the backlight devices is measured, measurement results shown in FIGS. 11 and 12. In FIGS. 11 and 12, a vertical axis is relative luminance of emitted light from the backlight devices and a horizontal axis is angle (in units of “degrees”) relative to a frontal direction. The relative luminance of the vertical axis in FIGS. 11 and 12 is a relative value in which the luminance value in the frontal direction is a reference (1.0). Graph drawn in a solid line in FIGS. 11 and 12 indicate a luminance distribution of emitted light emitted in the X-axis direction, and graphs drawn in a broken line indicate a luminance distribution of emitted light emitted in the Y-axis direction. Note that the only structural difference between the back light device 12 according to the present embodiment and the back light device of the comparison axis is the optical sheet 20 and the prism sheet.

Experiment results of the comparison experiment are described. First, as shown in FIG. 11, in the comparison example, the light focusing action by the prism sheet acts almost not at all on emitted light emitted in the X-axis direction, resulting in a smooth luminance distribution, whereas the light focusing action by the prism sheet acts on the emitted light emitted in the Y-axis direction, resulting in a steep luminance distribution. In other words, emitted light emitted from the prism sheet according to the comparison example in the Y-axis direction has excessive intensity in the frontal direction, and a discrepancy with intensity in diagonal directions is too large. Specifically, the prism sheet according to the comparison example is such that a full angle at half maximum (a range of angles at which the relative luminance is 0.5 or greater) for the emitted light emitted in the X-axis direction is relatively wide, at around 24°, whereas the full angle at half maximum for the emitted light emitted in the Y-axis direction is relatively narrow, at around 17°. Thus, in the comparison example, a discrepancy occurs in the range of angles within which a fixed or greater luminance can be achieved between the emitted light emitted in the X-axis direction and the emitted light emitted in the Y-axis direction, viewing angle characteristics in the Y-axis direction thus deteriorating.

In contrast, as shown in FIG. 12, with the optical sheet 20 according to the present embodiment, the light focusing action by the anisotropic light focusing part 41 acts almost not at all and the light diffusion action by the anisotropic light diffusing part 42 acts almost not at all (light diffusion is suppressed) on the emitted light emitted in the X-axis direction, resulting in a smooth luminance distribution. On the other hand, because the light focusing action by the anisotropic light focusing part 41 acts and the light diffusion action by the anisotropic light diffusing part 42 acts in a significant manner (light diffusion is promoted) on the emitted light emitted in the Y-axis direction in the present embodiment, a smooth luminance distribution results. Specifically, the optical sheet 20 according to the present embodiment is such that a full angle at half maximum (a range of angles at which the relative luminance is 0.5 or greater) for the emitted light emitted in the X-axis direction is around 26°, whereas the full angle at half maximum for the emitted light emitted in the Y-axis direction is around 26°, both therefore being substantially the same value. Thus, in the present embodiment, the range of angles within which a fixed or greater luminance can be achieved is substantially the same for the emitted light emitted in the X-axis direction and the emitted light emitted in the Y-axis direction, and therefore wide viewing angle characteristics are obtained for both directions.

Thus, as described above, the optical member (the optical member) 20 of the present invention includes the base material 40 which forms a sheet having transparent characteristics, one face of which is the light-receiving surface 40a into which light enters and another face of which is the light exiting surface 40b out of which light is emitted; the anisotropic light focusing part 41 that is formed on the light-receiving surface 40a of the base material 40 and has light focusing anisotropy whereby the light focusing action is applied to incident light in a light focusing direction along the light-receiving surface 40a but no light focusing action is applied in the non-light focusing direction along the light-receiving surface 40a and orthogonal to the light focusing direction; and the anisotropic light diffusing part 42 that is formed on the light exiting surface 40b of the base material 40 and diffuses and emits light from the anisotropic light focusing part 41, and is provided with the anisotropic light diffusing particles 45 that form an elongated shape and are disposed such that the long-axis direction is in the non-light focusing direction and the short-axis direction is in the light focusing direction, thereby having light diffusion anisotropy such that the intensity of diffused light is relatively large in the light focusing direction and the intensity of diffused light in the non-light focusing direction is relatively small.

In this manner, light entering the light-receiving surface 40a of the sheet-shaped base material 40 is subject to the light focusing action in the light focusing direction by the anisotropic light focusing part 41 that has light focusing anisotropy, but is not subject to a light focusing action in the non-light focusing direction. Light that passes through the base material 40 from the anisotropic light focusing part 41 and reaches the anisotropic light diffusing part 42 that is formed on the light exiting surface 40b is emitted while being subject to a diffusion action by the anisotropic light diffusing part 42. Here, the anisotropic light diffusing part 42 is provided with anisotropic light diffusing particles 45 that have an elongated shape and are disposed such that the long-axis direction is in the non-light focusing direction and the short-axis direction is in the light focusing direction, thereby having light diffusion anisotropy such that the intensity of diffused light is relatively large in the light focusing direction and the intensity of diffused light in the non-light focusing direction is relatively small. Diffusion of light that is subject to the light focusing action by the anisotropic light focusing part 41 is promoted by anisotropic light diffusing part 42, and diffusion of light that is not subject to the light focusing action by the anisotropic light focusing part 41 is suppressed. In this manner, frontal luminance of emitted light of the optical sheet 20 can be increased by focusing light in the light focusing direction with the anisotropic light focusing part 41, and directionality that can occur in emitted light can be mitigated by the anisotropic light diffusing part 42 that has light diffusion anisotropy.

Furthermore, the anisotropic light diffusing part 42 is laminated on the light exiting surface 40b in the base material 40 and is provided with the transparent resin layer 44 in which a plurality of the anisotropic light diffusing particles 45 are dispersed and mixed, and the anisotropic light diffusing particles 45 are oriented such that in the transparent resin layer 44 the long-axis direction is in the non-light focusing direction and the short-axis direction is in the light focusing direction. In this manner, light that passes through the base material 40 from the anisotropic light focusing part 41 and reaches the anisotropic light diffusing part 42 is diffused, such that the intensity of diffused light is greater in the light focusing direction and the intensity of diffused light is lower in the non-light focusing direction, due to the anisotropic light diffusing particles 45 that are dispersed and mixed in the transparent resin layer and oriented such that the long-axis direction is in the non-light focusing direction and the short-axis direction is in the light focusing direction. Moreover, when manufacturing the optical sheet 20, if the anisotropic light diffusing part is laminated and formed by applying and solidifying the liquid transparent resin layer 44, in which a plurality of the anisotropic light diffusing particles 45 have been dispersed and mixed, on the light exiting surface 40b of the base material 40, for example, the anisotropic light diffusing particles 45 can be oriented easily as the long-axis direction of the anisotropic light diffusing particles 45 is arranged in a direction of application during application.

Furthermore, the anisotropic light diffusing particles 45 form a narrowing shape from the central side to both end sides in the long-axis direction. Thus, by laminating and forming the anisotropic light diffusing part 42 by applying and solidifying the liquid transparent resin layer 44 in which the plurality of the anisotropic light diffusing particles 45 are dispersed and mixed on the light exiting surface 40b of the base material 40, for example, during manufacturing of the optical sheet 20, the long-axis direction of the anisotropic light diffusing particles can be arranged during application in the direction of application more smoothly than in a case in which the anisotropic light diffusing particles 45 have a fixed thickness along an entire length thereof in the long-axis direction. An oriented state of the plurality of the anisotropic light diffusing particles 45 in the transparent resin layer can thus be made more appropriate.

Furthermore, the anisotropic light diffusing particles 45 are such that the cross-sectional shape cut along the long-axis direction forms an elliptical shape. The end portions in the long-axis direction of the anisotropic light diffusing particles 45 thus have rounded shapes, and therefore there is less catching during a process in which the anisotropic light diffusing particles are oriented during application in a case in which the anisotropic light diffusing part 42 is laminated and formed by applying and solidifying the liquid transparent resin layer 44 in which are dispersed and mixed a plurality of the anisotropic light diffusing particles 45 on a light exiting surface 40b of the base material 40, for example, during manufacturing of the optical sheet 20. The long-axis directions of the anisotropic light diffusing particles 45 can thus be arranged even more smoothly so as to be in the direction of application, and an oriented state of the plurality of the anisotropic light diffusing particles 45 in the transparent resin layer 44 can be made even more appropriate.

Furthermore, the anisotropic light diffusing particles 45 are formed such that a cross-sectional shape cut along the short-axis direction forms a circular shape. Thus, compared to a case in which the anisotropic light diffusing particles 45 have a cross-sectional shape cut along the short-axis direction which is squared, there is less catching during a process in which the anisotropic light diffusing particles 45 are oriented during application in a case in which the anisotropic light diffusing part 42 is laminated and formed by applying and solidifying the liquid transparent resin layer in which are dispersed and mixed a plurality of the anisotropic light diffusing particles 45 on a light exiting surface 40b of the base material 40, for example, during manufacturing of the optical sheet 20. The long-axis direction of the anisotropic light diffusing particles 45 can thus be arranged during application more smoothly so as to be in the direction of application, and an oriented state of the plurality of the anisotropic light diffusing particles 45 in the transparent resin layer 44 can be made more appropriate.

Furthermore the anisotropic light focusing part 41 includes, arranged parallel to the light focusing direction, a plurality of the prisms 43 that protrude from the light-receiving surface 40a, have cross-sectional shapes cut along the light focusing direction that substantially form ridge shapes, and extend linearly in the non-light focusing direction. Furthermore the anisotropic light focusing part 41 includes, arranged parallel to the light focusing direction, a plurality of the prisms 43 that protrude from the light-receiving surface 40a, have cross-sectional shapes cut along the light focusing direction that substantially form ridge shapes, and extend linearly in the non-light focusing direction. The light focusing action is thus applied to light directed at the base material 40 from the prisms 43 along the light focusing direction. On the other hand, because the prisms 43 extend linearly in the non-light focusing direction, no light focusing action is applied to light directed toward the base material 40 from the prisms 43 along the non-light focusing direction.

Next, the backlight device (illumination device) 12 of the present embodiment is provided with the optical sheet 20 described above, the LEDs (light sources) 17, and the light guide plate 19 that has the light-receiving face 19b into which light from the LEDs 17 enters and the light-exiting surface 19a that forms a state of opposition with the light-receiving surface 40a of the optical sheet 20 and from which light is emitted. With the backlight device 12 of this configuration, light from the LEDs 17 enters the light-receiving face 19b of the light guide plate 19, is propagated through the light guide plate 19, and is then emitted from the light-exiting surface 19a, thereby entering the light-receiving surface 40a of the optical sheet 20. Because the frontal luminance related to the emitted light from the optical sheet 20 is high and directionality which can occur in the emitted light is mitigated, luminance unevenness does not readily occur as frontal luminance is high and orientation which can occur in the emitted light is mitigated in the backlight device 12, too.

Furthermore, in the backlight device 12 thus described, the anisotropic light focusing part 41 includes the prisms 43 that substantially form ridge shapes in which the cross-sectional shape cut along the direction of arrangement of the LEDs 17 and the light guide plate 19 has the pair of slanted faces 43a, and that extend linearly along the direction orthogonal to the direction of arrangement, arranged in a plurality on the light-receiving surface 40a of the optical sheet 20 in the direction of arrangement. In this manner, the direction of propagation of light from the light-exiting surface 19a of the light guide plate 19 to the light-receiving surface 40a of the optical sheet 20 tilts generally towards the light-exiting surface 19a, and includes a component in a direction of a normal of the light-exiting surface 19a and a component in a direction from the LEDs 17 towards the light-receiving face 19b of the light guide plate 19. In contrast, the anisotropic light focusing part 41 substantially forms ridge shapes in which the cross-sectional shape cut along the direction of arrangement of the LEDs 17 and the light guide plate 19 has the pair of the slanted faces 43, and therefore light entering the prisms 43 along the direction of propagation can efficiently be raised to the frontal direction. Frontal luminance can thereby be efficiently improved.

Next, the liquid crystal display device (display device) 10 of the present embodiment is provided with the backlight device 12 and the liquid crystal panel 11, which is a display panel that performs display by using light from the backlight device 12. With the liquid crystal display device 10 of this configuration, frontal luminance relating to emitted light of the backlight device 12 is high and luminance unevenness does not readily occur, and therefore display with outstanding display quality can be realized.

Furthermore, the display panel is the liquid crystal panel 11 in which liquid crystal is sealed in between the pair of substrates 11a and 11b. The liquid crystal display device 10 in this manner can be applied to many uses, such as, for example, displays for smartphones and tablet-type personal computers.

### Embodiment 2

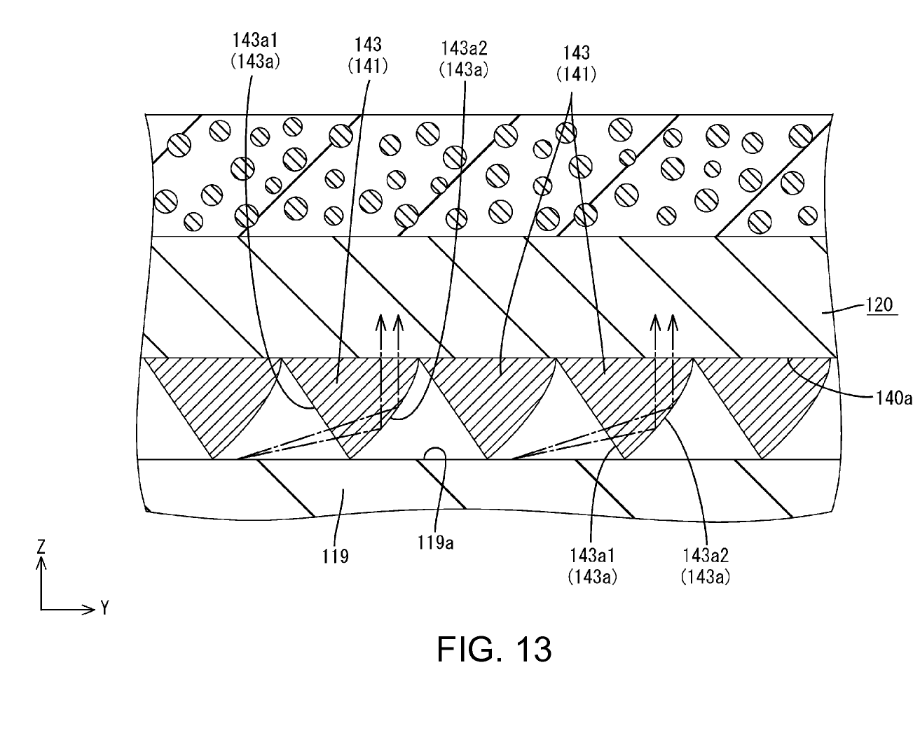

Embodiment 2 of the present invention is described with reference to FIG. 13. Embodiment 2 shows a modified configuration of an anisotropic light focusing part 141. Note that redundant descriptions of structures, actions, and effects which are the same as in Embodiment 1 described above are omitted.

As shown in FIG. 13, prisms 143 that make up the anisotropic light focusing part 141 according to the present embodiment are such that a cross-sectional shape of one slanted face 143a1 of a pair of slanted faces 143a is a substantially straight line, and a cross-sectional shape of another slanted face 143a2 is a curved line curved in a circular shape. In other words, the prisms 143 are such that a cross-sectional shape cut along a Y-axis direction is asymmetrical. Note that in the following to distinguish the pair of slanted faces 143a, the number “1” is added to the reference character of one of the slanted faces and the number “2” is added to the reference character of the other slanted face, and no number is added when no distinction is made. The slanted face 143a1 is disposed on the left side in FIG. 13 relative to an apex of the prism 143, that is, on a side relatively close to the LEDs (a light-receiving face of a light guide plate 119), whereas the other slanted face 143a2 is disposed to the right in the drawing relative to the apex of the prism 143, that is, on a side relatively far from the LEDs (the light-receiving face of the light guide plate 119). Emitted light from a light-exiting surface 119a of the light guide plate 119 is such that a direction of propagation thereof is tilted towards the light-exiting surface 119a, and includes a component of a frontal direction and a component of a direction from the LEDs towards the light-receiving face of the light guide plate 119. In contrast, the cross-sectional shape of the other slanted face 143a2 in the prisms 143 is a circularly curved line, and therefore light entering the prisms 143 in the aforementioned direction of propagation from the light-exiting surface 119a can efficiently be raised towards the frontal direction. A light focusing action by the anisotropic light focusing part 141 can thereby be made higher, and a frontal luminance can be improved even more.

With the present embodiment as described above, the anisotropic light focusing part 141 includes the prisms 143 that substantially form ridge shapes in which the cross-sectional shape cut along the direction of arrangement of the LEDs and the light guide plate 119 has the pair of slanted faces 143a, and that extending linearly along a direction orthogonal to the direction of arrangement, arranged in the direction of arrangement on a light-receiving surface 140a of an optical sheet 120, the prisms 143 because such that, of the pair of slanted faces 143a, the cross-sectional shape of the slanted face 143a2 opposite the LEDs side is a curved line. In this manner, the direction of propagation of light from the light-exiting surface 119a of the light guide plate 119 to the light-receiving surface 140a of the optical sheet 120 tilts generally towards the light-exiting surface 119a, and includes a component in a direction normal to the light-exiting surface 119a and a component in a direction from the LEDs towards the light-receiving face of the light guide plate 119. In contrast, because the anisotropic light focusing part 141 substantially forms the ridge shapes in which the cross-sectional shape cut along the direction of arrangement of the LEDs and the light guide plate 119 has the pair of slanted faces 143a, and of the pair of slanted faces 143a the cross-sectional shape of the slanted face 143a2 opposite the LEDs is a curved line, light entering the prisms 143 in the aforementioned direction of propagation can efficiently be raised towards the frontal direction. Frontal luminance can thereby be efficiently improved.

### Embodiment 3

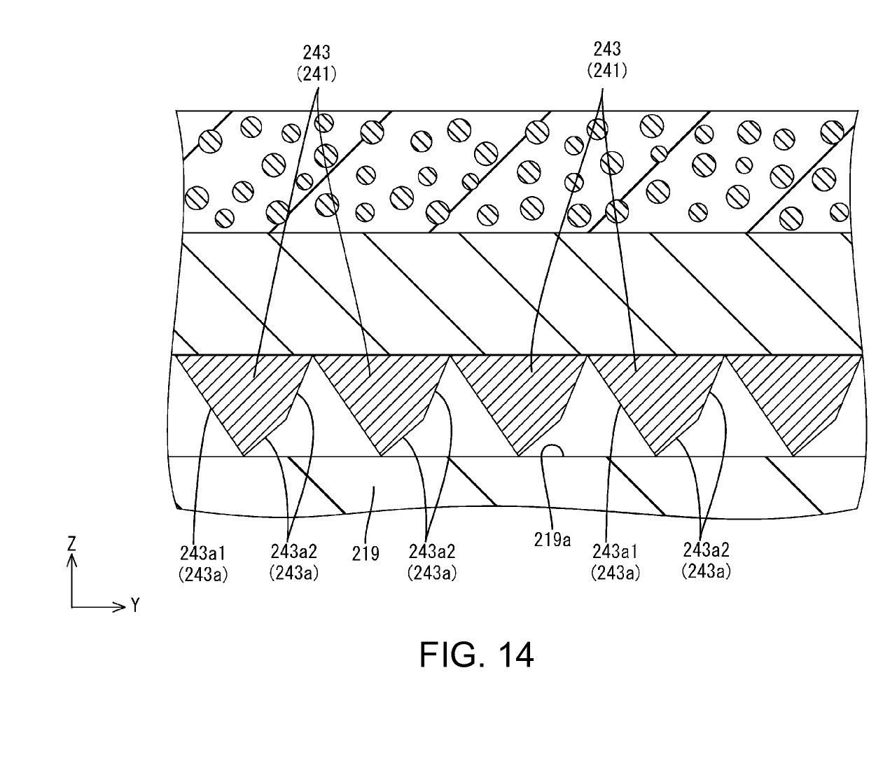

Embodiment 3 of the present invention is described with reference to FIG. 14. Embodiment 3 shows a further modification of a configuration of an anisotropic light focusing part 241 from Embodiment 3. Note that redundant descriptions of structures, actions, and effects which are the same as in Embodiment 1 described above are omitted.

As shown in FIG. 14, prisms 243 that make up the anisotropic light focusing part 241 according to the present embodiment are such that a cross-sectional shape of one slanted face 243a1 (on a side relatively close to the LEDs) of a pair of slanted faces 243a is a substantially straight line, and a cross-sectional shape of another slanted face 243a2 (on a side relatively far away from the LEDs) is a polygonal line in which two slanted lines are connected. With the prisms 243 of this configuration, light entering the prisms 243 in a diagonal direction relative to the frontal direction from a light-exiting surface 219a can efficiently be raised toward the frontal direction by the other slanted face 243a2, a similar effect as in Embodiment 3 thereby being able to be obtained.

### Embodiment 4

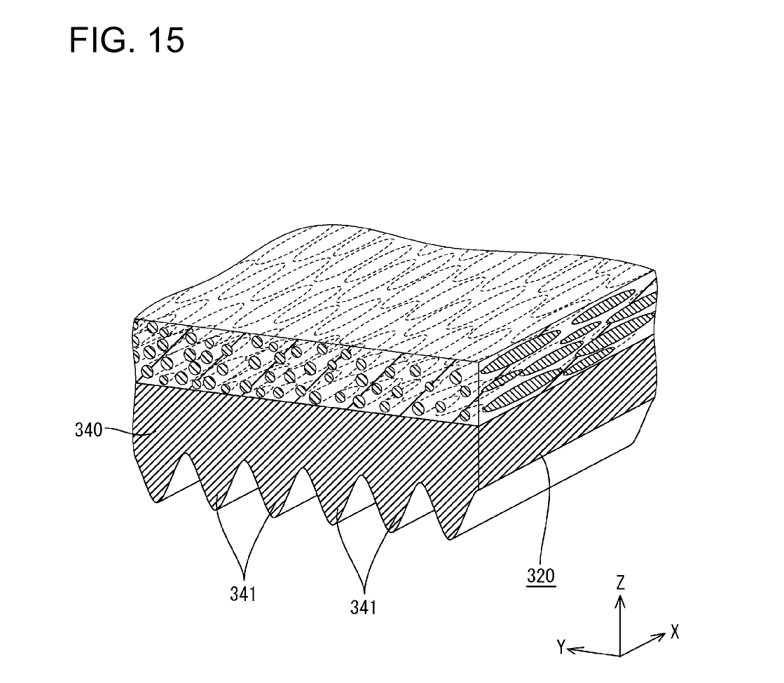

Embodiment 4 of the present invention is described with reference to FIG. 15. Embodiment 4 shows a base material 340 and an anisotropic light focusing part 341 integrally molded from the same material. Note that redundant descriptions of structures, actions, and effects which are the same as in Embodiment 1 described above are omitted.

As shown in FIG. 15, the base material 340 and the anisotropic light focusing part 341 of an optical sheet 320 according to the present embodiment include a single thermoplastic resin material such as PET. When manufacturing the optical sheet 320, the base material 340 and the anisotropic light focusing part 341 can be molded together with an injection molding method. Besides this, a heat imprinting method can also be used, for example; specifically, the anisotropic light focusing part 341 can be molded by heating the sheet-shaped base material 340 in which a rear side face (a light-receiving surface 340a) is a smooth face and applying a transfer die to the face thereof, thereby transferring a surface shape of the transfer die to a face of the base material 340. Furthermore, the base material 340 and the anisotropic light focusing part 341 can be manufactured using an extrusion molding method as well. Thus, if the base material 340 and the anisotropic light focusing part 341 are molded integrally from the same material, the base material 40 is not subjected to biaxial stretching as in Embodiment 1, and therefore product-by-product non-uniformity does not readily occur in changes to a light polarization state that can occur when light passes through the base material 340 during mass production of the optical sheet 320. Optical characteristics related to emitted light of the optical sheet 320 are thus made stable.

### Embodiment 5

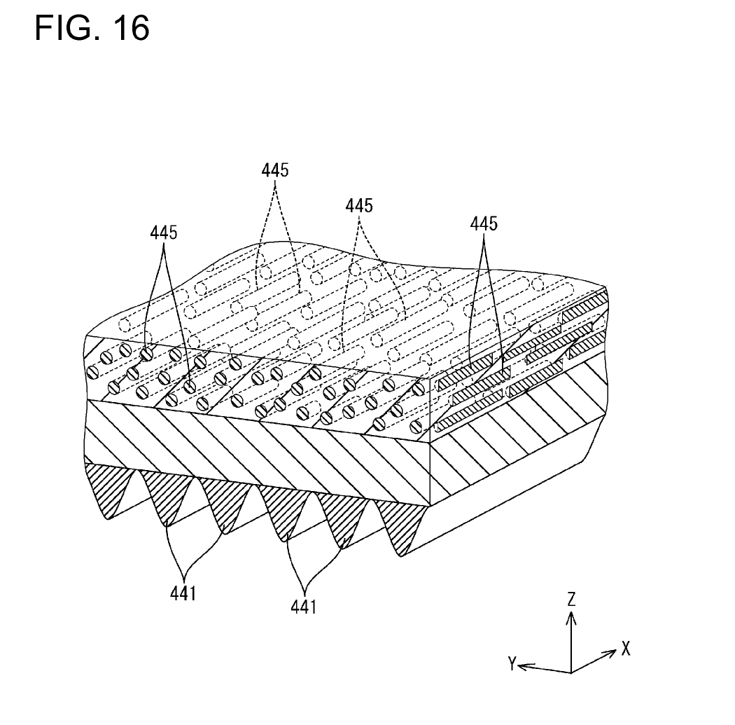

Embodiment 5 of the present invention is described with reference to FIG. 16. Embodiment 5 shows a modified configuration of anisotropic light diffusing particles 445. Note that redundant descriptions of structures, actions, and effects which are the same as in Embodiment 1 described above are omitted.

As shown in FIG. 16, the anisotropic light diffusing particles 445 according to the present embodiment have a substantially round columnar shape. The anisotropic light diffusing particles 445 form a rectangular shape in which a cross-sectional shape cut along a long-axis direction (an X-axis direction) is a rectangular shape, whereas a cross-sectional shape cut along a short-axis direction (a Y-axis direction) is circular shape, and a diameter dimension along an entire length in the long-axis direction (dimension for the short-axis direction) is substantially fixed. Even with the anisotropic light diffusing particles 445 in this shape, making an orientation thereof such that the long-axis direction coincides with the light focusing direction of the anisotropic light focusing part 441 and the short-axis direction coincides with the non-light focusing direction of the anisotropic light focusing part 441 promotes diffusion for light subjected to the light focusing action by the anisotropic light focusing part 441, whereas diffusion is suppressed for light to which the light focusing action is applied almost not at all by the anisotropic light focusing part 441, thereby making it possible to appropriately mitigate directionality which occurs in emitted light.

### Embodiment 6

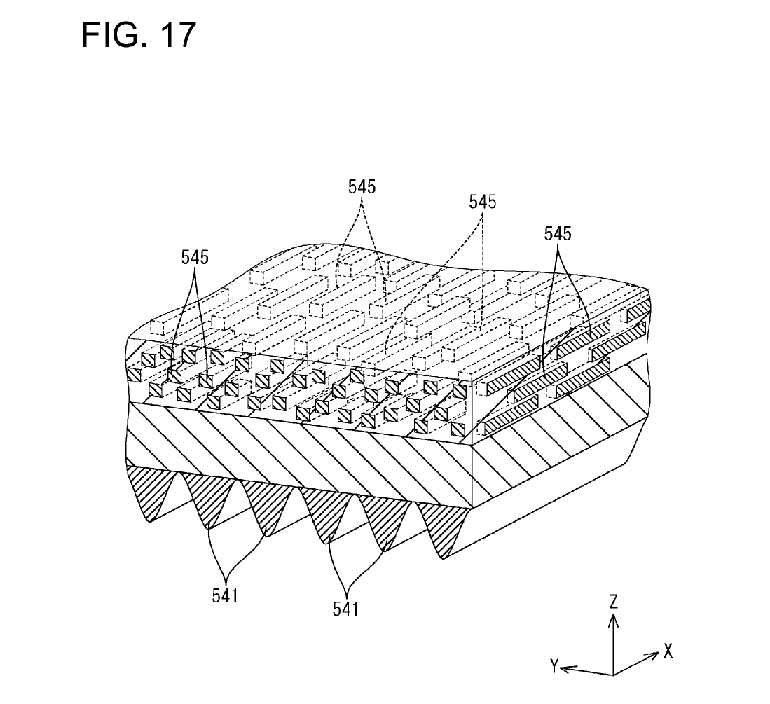

Embodiment 6 of the present invention is described with reference to FIG. 17. Embodiment 6 shows a modified configuration of anisotropic light diffusing particles 545. Note that redundant descriptions of structures, actions, and effects which are the same as in Embodiment 1 described above are omitted.

As shown in FIG. 17, the anisotropic light diffusing particles 545 according to the present embodiment have a square columnar shape. The anisotropic light diffusing particles 545 form a rectangular shape in which a cross-sectional shape cut along a long-axis direction (an X-axis direction) is a rectangular shape, whereas a cross-sectional shape cut along a short-axis direction (a Y-axis direction) is square shape, and dimensions of each side along an entire length in the long-axis direction (dimension for the short-axis direction) are substantially fixed. Even with the anisotropic light diffusing particles 545 in this shape, making an orientation thereof such that the long-axis direction coincides with the light focusing direction of the anisotropic light focusing part 545 and the short-axis direction coincides with the non-light focusing direction of the anisotropic light focusing part 541 promotes diffusion for light subjected to the light focusing action by the anisotropic light focusing part 541, whereas diffusion is suppressed for light to which the light focusing action is applied almost not at all by the anisotropic light focusing part 541, thereby making it possible to appropriately mitigate directionality which occurs in emitted light.

### Other Embodiments

The present invention is not limited to the embodiments described by the text above and the drawings, the following types of embodiments are also included in a technical scope of the present invention.

(1) In the above embodiments, an arrangement of the anisotropic light diffusing particles in the transparent resin layer was shown as random, but a configuration is also possible in which the anisotropic light diffusing particles are arranged with fixed regularity in the transparent resin layer 44.

(2) Besides the above embodiments, specific shapes and sizes (dimensions in the long-axis direction and dimensions in the short-axis direction) of the anisotropic light diffusing particles can be modified as appropriate. For example, it is possible to use anisotropic light diffusing particles that form elliptical columnar shapes or in which a cross-sectional shape cut along the short-axis direction forms a polygon having three or five or more angles. Furthermore, it also possible to used anisotropic light diffusing particles that have a narrowing shape by providing conical portions to both end portions in the long-axis direction in the round column portions or that have a narrowing shape by providing pyramidal portions (triangular pyramidal portions, quadrangular pyramidal portions, etc.) to both end portions in the long-axis direction of the angular column portions (triangular column portions, quadrangular column portions, etc.). Furthermore, it is also possible to use anisotropic light diffusing particles that have a narrowing shape by using a shape in which bottom portions of two conical portions are adhered back-to-back, or that have a narrowing shape by using a shape in which bottom portions of pyramidal portions (triangular pyramidal portions, quadrangular pyramidal portions, etc.) are adhered back-to-back.

(3) Besides the above embodiments, specific types of materials and numerical values of refractive indices of materials, etc., used in the anisotropic light diffusing particles and the transparent resin layer can be modified as appropriate. For example, aside from the ultraviolet ray curing resin, visible light curing resin or the like that is cured by visible light can be used as a material used in the transparent resin layer. Furthermore, a relationship of size between a refractive index of the anisotropic light diffusing particles and a refractive index of the transparent resin layer can be set freely, and it is possible to make the former larger than the latter, inversely to make the former smaller than the latter, and moreover to make both the same. Furthermore, it is possible to make the materials used in the anisotropic light diffusing particles and the transparent resin layer different or the same.

(4) Besides the embodiments above, specific numerical values relating to a weight ratio of the anisotropic light diffusing particles to the transparent resin layer can be modified as appropriate.

(5) In the above embodiments, embodiments were shown in which the thickness of the anisotropic light diffusing part is larger than the thickness of the base material, but it is also possible to reverse the relationship of thickness and use a configuration in which the thickness of the anisotropic light diffusing part is larger than the thickness of the base material.

(6) In Embodiment 2 described above, a case was shown in which a cross-sectional shape of the other slanted face in the prism is a circular curved line, but it is also possible to make the cross-sectional shape of the other slanted face a non-circular curved line (e.g., a waveform, etc.).

(7) In Embodiment 3 described above, a case was shown in which the cross-sectional shape of the other slanted face in the prism is a polygonal line in which two slanted lines are connected, but it is also possible to make the cross-sectional shape of the other slanted face a polygonal line in which three or more diameter lanes are connected.

(8) In the above embodiments, a case was shown in which an ultraviolet ray curing resin material which is one type of light curing resin material in which curing is promoted by ultraviolet rays was used as the material for the anisotropic light focusing part, but it is also possible to use another light curing resin material, and a visible light curing resin material in which curing is promoted by visible light rays, for example, can be used. Besides that, it is also possible to use a light curing resin material of a type in which curing is promoted both by ultraviolet rays and visible light rays.

(9) In the above embodiments, embodiments were shown in which the anisotropic light focusing part and the transparent resin layer of the anisotropic light diffusing part included different materials, but it is also possible to make the materials used in the anisotropic light focusing part and the transparent resin layer of the anisotropic light diffusing part the same.

(10) In the above embodiments, a case was shown in which the refractive index of the material forming the anisotropic light focusing part is the same as the refractive index of the light guide plate, but it is also possible to make the refractive index of the material forming the anisotropic light focusing part higher than the refractive index of the light guide plate or, conversely, lower.

(11) In Embodiments 1 to 3, a case was shown in which the base material was manufactured using a biaxial stretching method, but it is also possible to manufacture the base material using another method, such as for example an extrusion molding method, an injection molding method, or the like.

(12) In the embodiments described above, a case was shown in which the light focusing direction of the anisotropic light focusing part coincides with the Y-axis direction and the non-light focusing direction coincides with the X-axis direction, but it is also possible to adopt an arrangement in which the light focusing direction of the anisotropic light focusing part coincides with the X-axis direction and the non-light focusing direction coincides with the Y-axis direction, and in this case the short-axis direction (strong diffusion direction) of the anisotropic light diffusing particles in the anisotropic light diffusing part need only be made to coincide with the X-axis direction and the long-axis direction (weak diffusion direction) with the Y-axis direction.

(13) In the above embodiments, a case was shown in which only one optical sheet was used, but it is also possible to add other types of optical sheet (diffusion sheets, prism sheets, reflective light polarizing sheets, etc.).

(14) In the above embodiments, a configuration was shown in which one LED substrate is disposed along the light-receiving face of the light guide plate, but a configuration in which two or more LED substrates are disposed arranged along the light-receiving face of the light guide plate is also included in the present invention.

(15) In the above embodiments, a case was shown in which the LED substrate is disposed in a state of opposition with respect to one long-side side end face of the light guide plate, but a configuration in which the LED substrate is disposed in a state of opposition to one short-side side end face of the light guide plate is also included in the present invention.

(16) Aside from (15) above, a configuration in which the LED substrate is disposed in a state of opposition to a pair of long-side side end faces of the light guide plate or a configuration in which the LED substrate is disposed in a state of opposition to a pair of short-side side end faces of the light guide plate are also included in the present invention.

(17) Aside from (15) and (16) above, a configuration in which the LED substrate is disposed in a state of opposition to any three end faces of the light guide plate or a configuration in which the LED substrate is disposed in a state of opposition to all four end faces of the light guide plate are also included in the present invention.

(18) In the embodiments above, a projection-type electrostatic capacitance system was shown as an example of a touch panel pattern of the touch panel, but a configuration adopting a surface-type electrostatic capacitance system, a resistance film system, an electromagnetic induction system, and so on can also be applied to the present invention.

(19) In lieu of the touch panel described in the embodiments above, it is possible to use, for example, a parallax barrier panel (switching liquid crystal panel) having a parallax barrier pattern for causing an observer to observe an image that is displayed on a display surface of the liquid crystal panel as a 3D image (3D image, three-dimensional image) by splitting the image using parallax. Furthermore, the parallax barrier panel described above can be in combination with the touch panel.

(20) It is also possible form a touch panel pattern in the parallax barrier panel described in (19), thereby causing the parallax barrier panel to have touch panel functionality as well.

(21) In the above embodiments, an example was shown of a case in which a screen size of the liquid crystal panel used in the liquid crystal display device was around 20 inches, but it is also possible to modify a specific screen size of the liquid crystal panel to a size other than 20 inches as appropriate. It is preferable to use such a screen in an electronic device such as a smartphone particularly in a case in which the screen size is around a few inches.

(22) In the above embodiments, an example was shown of the three colors R, G, and B used as in colored portions of the color filter that the liquid crystal panel has, but it is also possible to use four or more colors for the colored portions.

(23) In the above embodiments, a case was shown in which LEDs were used as the light source, but it is also possible to use other light sources.

(24) In the above embodiments, a case was shown in which the frame was made out of metal, but it is also possible to make the frame out of a synthetic resin.

(25) In the above embodiments, a case was shown in which reinforced glass treated with a chemical reinforcement process was used as the cover panel, but it is also naturally possible to use reinforced glass treated with an air-cooling reinforcement process (physical reinforcement process).

(26) In the above embodiments, a case was shown in which reinforced glass was used as the cover panel, but it is naturally also possible to use an ordinary glass material (non-reinforced glass) or a synthetic resin material which are not reinforced glass.

(27) In the above embodiments, a case was shown in which the cover panel was used in the liquid crystal display device, but it is also possible to omit the cover panel. Similarly the touch panel can also be omitted.

(28) In the above embodiments, a case was shown in which an edge-lit type was used as the backlight device that the liquid crystal display device is provided with, but using a directly-lit type backlight device is also possible.

(29) In the above embodiments, an example was shown of a liquid crystal display device in which the display screen is a horizontally long type, but a liquid crystal display device in which the display screen is a vertically long type is also included in the present invention. Furthermore, a liquid crystal display device in which the display screen square is also included in the present invention.

(30) In the above embodiments, TFTs were used as the switching elements of the liquid crystal display device, but a liquid crystal display device using switching elements other than TFTs (thin-film diodes (TFDs), for example) is also applicable, and besides liquid crystal display devices which display color, liquid crystal display devices which display black and white are also applicable.

### DESCRIPTION OF THE REFERENCE CHARACTERS

10 liquid crystal display device (display device)
11 liquid crystal panel (display panel)
11a, 11b substrate
12 backlight device (illumination device)
17 LED (light source)
19, 119, 219 light guide plate
19a, 119a, 219a light-exiting surface
19b light-receiving face
20, 120, 220, 320 optical sheet (optical member)
40, 140, 340 base material
40a, 240a light-receiving surface
40b, 140b light exiting surface
41, 141, 241, 341, 441, 541 anisotropic light focusing part
42 anisotropic light diffusing part
43, 143, 243 prism
43a, 143a, 342a slanted face
44 transparent resin layer
45, 445, 545 anisotropic light diffusing particles
143a1, 243a1 slanted face
143a2, 243a2 slanted face

1. An optical member, comprising:
a base material that is transparent and has a sheet-like shape, one surface of the base material being a light-receiving surface where light enters and another surface thereof being a light-exiting surface where light exits;
an anisotropic light focusing part that is formed over the light-receiving surface of the base material and that exerts, on incident light, a light focusing effect in a light focusing direction along the light-receiving surface of the base material, but does not exert a light focusing effect in a non-light focusing direction along the light-receiving surface of the base material, said non-light focusing direction being perpendicular to said light focusing direction; and
an anisotropic light diffusing part that is formed over the light exiting surface of the base material and that diffuses and emits light from the anisotropic light focusing part, said anisotropic light diffusing part comprising anisotropic light diffusing particles having an elongated shape, a long-axis direction of said elongated shape being in the non-light focusing direction and a short-axis direction thereof being in the light focusing direction, thereby relatively increasing an amount of light diffused in the light focusing direction and relatively decreasing an amount of light diffused in the non-light focusing direction.

2. The optical member according to claim 1,
wherein the anisotropic light diffusing part comprises a transparent resin layer that is stacked on the light-exiting surface of the base material and that has the anisotropic light diffusing particles dispersed therein, and
wherein, in the transparent resin layer, the anisotropic light diffusing particles are oriented such that the long-axis direction is along the non-light focusing direction and the short-axis direction is along the light focusing direction.

3. The optical member according to claim 2, wherein the anisotropic light diffusing particles each have a shape that tapers from a center to both ends thereof in the long-axis direction.

4. The optical member according to claim 3, wherein the anisotropic light diffusing particles each have a cross-sectional shape that is elliptical along the long-axis direction.

5. The optical member according to claim 2, wherein the anisotropic light diffusing particles each have a cross-sectional shape that is circular along the short-axis direction.

6. The optical member according to claim 1, wherein the anisotropic light focusing part comprises a plurality of prisms, arranged parallel to the light focusing direction, that protrude from the light-receiving surface, said prisms having a substantially ridge-shaped cross section along the light focusing direction and extending linearly in the light focusing direction.

7. An illumination device, comprising:
the optical member according to claim 1;
a light source; and
a light guide plate that has a light-receiving face where light from the light source enters, and a light-exiting surface where light exits, said light-exiting surface of the light guide plate facing the light-receiving surface of the optical member.

8. The illumination device according to claim 7,
wherein the anisotropic light focusing part of the optical member comprises a plurality of prisms, arranged along an arrangement direction of the light source and the light guide plate, that are formed over the light-receiving surface of the optical member, said prisms having a substantially ridge-shaped cross section with a pair of slanted faces along said arrangement direction and extending linearly in a direction perpendicular to said arrangement direction, and
wherein, with respect to the cross section of the prisms, one of said slanted faces opposite to the light source is a curved line or a polygonal line.

9. A display device, comprising:
the illumination device according to claim 7; and
a display panel that performs display with light from said illumination device.

10. The display device according to claim 9, wherein the display panel is a liquid crystal panel comprising liquid crystal sealed between a pair of substrates.
